(19) United States
(12) Patent Application Publication
(10) Pub. No.: US 2025/0367870 A1
(43) Pub. Date: Dec. 4, 2025

(54) IMPROVED ADHESION OF FDM PRINTED LAYER TO A METAL PART

(71) Applicant: SIGNIFY HOLDING B.V., EINDHOVEN (NL)

(72) Inventors: TIES VAN BOMMEL, HORST (NL); RIFAT ATA MUSTAFA HIKMET, EINDHOVEN (NL)

(21) Appl. No.: 18/876,383

(22) PCT Filed: Jul. 4, 2023
(86) PCT No.: PCT/EP2023/068302

§ 371 Date: Dec. 18, 2024

(30) Foreign Application Priority Data
Jul. 11, 2022 (EP) 22184059.8

(51) Int. Cl. B29C 64/118; B29C 64/209; B29C 64/336; B29K 103/06; B29K 705/00; B29L 31/34; B33Y 10/00; B33Y 40/10; B33Y 70/10; B33Y 80/00

(52) U.S. Cl. CPC B29C 64/118; B29C 64/209; B29C 64/336; B33Y 10/00; B33Y 40/10; B33Y 70/10; B33Y 80/00; B29K 2103/06; B29K 2705/00; B29L 2031/3481

(57) ABSTRACT

The invention provides a method for providing a composite object (400) comprising a 3D printed part (1) adhering to a metal part (420), wherein: the method comprises the step of providing the metal part (420) followed by a 3D printing stage comprising layer-wise depositing 3D printable material (201) by means of fused deposition modeling on the metal part (420), to provide the composite object (400); wherein the 3D printed part (1) comprises a layer (322) of 3D printed material (202); the 3D printing stage comprises guiding the 3D printable material (201) through a printer nozzle (502) at a nozzle temperature TN; during a first 3D printing stage of the 3D printing stage, wherein 3D printable material (201) is deposited on the metal part (420), the following applies: (i) the 3D printable material (201) comprises first 3D printable material (2011) comprising a thermoplastic material (401) and metal particles (410); wherein metal (411) of the metal particles (410) has a melting temperature TP, and (ii) TN>TP.

### FIELD OF THE INVENTION

The invention relates to a method for manufacturing a composite object comprising a 3D printed part adhering to a metal part. Further, the invention relates to a filament for using in such method. The invention also relates to the composite object comprising the metal part and the 3D printed part obtainable with such method. Further, the invention relates to a lighting device including such composite object.

### BACKGROUND OF THE INVENTION

Filaments comprising a metal and/or ceramic powder are known in the art. EP3167101, for instance, describes a filament suitable to be used in a 3D printing device, wherein the filament comprises or consists of (a) a metal and/or ceramic powder; (b) a thermoplastic binder comprising a thermoplastic polymer and at least one plasticizer; and (c) between 0 and 10 wt % of additives based on the total weight of the filament and wherein the filament has a shore A hardness of at least 85 at 20° C. and wherein the at least one plasticizer is a mixture of esters and wherein the mixture of esters comprises an ester which is solid at 20° C. and an ester that is liquid at 20° C.

### SUMMARY OF THE INVENTION

Within the next 10-20 years, digital fabrication will increasingly transform the nature of global manufacturing. One of the aspects of digital fabrication is 3D printing. Currently, many different techniques have been developed in order to produce various 3D printed objects using various materials such as ceramics, metals, and polymers.

The most widely used additive manufacturing technology is the process known as Fused Deposition Modeling (FDM). Fused deposition modeling (FDM) is an additive manufacturing technology commonly used for modeling, prototyping, and production applications. FDM works on an “additive” principle by laying down material in layers; a plastic filament or metal wire is unwound from a coil and supplies material to produce a part. Possibly, (for thermoplastics for example) the filament is melted and extruded before being laid down. FDM is a rapid prototyping technology. Other terms for FDM are “fused filament fabrication” (FFF) or “filament 3D printing” (FDP), which are considered to be equivalent to FDM. In general, FDM printers use a thermoplastic filament, which is heated to its melting point and then extruded, layer by layer, (or in fact filament after filament) to create a three-dimensional object. FDM printers are relatively fast, low cost and can be used for printing complicated 3D objects. Such printers are used in printing various shapes using various polymers. The technique is also being further developed in the production of LED luminaires and lighting solutions.

It appears desired to produce composite objects comprising 3D printed thermoplastic parts adhering to metal parts. However, the thermoplastic material may adhere poorly to the metal. Therefore, it may be difficult to produce long-lasting composite objects as the material interface between the thermoplastic material and metal may not be durable.

Hence, it is an aspect of the invention to provide an alternative 3D printing method and/or 3D (printed) item which preferably further at least partly obviate(s) one or more of above-described drawbacks. The present invention may have as object to overcome or ameliorate at least one of the disadvantages of the prior art, or to provide a useful alternative.

In a first aspect the invention provides a method for providing a composite object comprising a 3D printed part adhering to a metal part. Especially, the method may comprise providing the metal part followed by a 3D printing stage comprising layer-wise depositing an extrudate comprising 3D printable material by means of fused deposition modeling on the metal part, to provide the composite object. In embodiments, the composite object may comprise the metal part and the 3D printed part. Especially, the 3D printed part may comprise a layer of 3D printed material. In embodiments, the 3D printing stage may comprise guiding the 3D printable material through a printer nozzle at a nozzle temperature T_{N}. Especially, the 3D printing stage may comprise a first 3D printing stage wherein 3D printable material may be deposited on the metal part. In embodiments, during the first 3D printing stage the 3D printable material may comprise first 3D printable material. Especially, the first 3D printable material may comprise a thermoplastic material and metal particles. The metal particles may especially be at least partly embedded in the thermoplastic material. Especially, the metal of the metal particles has a melting temperature T_{P}. During the first 3D printing stage, in specific embodiments T_{N}>T_{P}. Hence, in specific embodiments the invention provides a method for providing a composite object comprising a 3D printed part adhering to a metal part, wherein: the method comprises providing the metal part followed by a 3D printing stage comprising layer-wise depositing 3D printable material by means of fused deposition modeling on the metal part, to provide the composite object; wherein the 3D printed part comprises a layer of 3D printed material; the 3D printing stage comprises guiding the 3D printable material through a printer nozzle at a nozzle temperature T_{N}; during a first 3D printing stage of the 3D printing stage, wherein 3D printable material is deposited on the metal part, the following applies: (i) the 3D printable material comprises first 3D printable material comprising a thermoplastic material and metal particles; wherein metal of the metal particles has a melting temperature T_{P}, and (ii) T_{N}>T_{P}.

In this way, the metal particles may (partially) melt during extrusion and at least part of the metal particles which are brought in contact with the metal part may adhere to the metal part. The metal particles may in embodiments deform as a consequence of the melting. As a consequence, the metal particles in the 3D printed part may have different dimensions and/or shapes compared to the metal particles prior to the 3D printing stage.

In embodiments, melted metal particles may be spherical (because of the relatively lower surface tension). In embodiments, melted metal particles may substantially have the same shape as the metal particles prior to melting.

After printing, the metal particles may solidify and may form a (mechanical) attachment with the metal part. As the metal particles may be largely embedded in the thermoplastic material of the first 3D printable material, the particles may form a durable connection between the thermoplastic material and the metal part. The metal particles that form such connection, may be referred to as connecting particles. The connecting particles may especially be deformed during deposition. The connecting particles may in embodiments comprise metal particles that were molten, deformed and solidified.

The composite object of the invention may especially comprise the metal part and the 3D printed part wherein the metal part and 3D printed part may be functionally coupled. The composite object may in embodiments be an object comprising a 3D printed part which is attached to the metal part. In embodiments, the composite object may comprise one or more 3D printed parts (attached to the (same) metal part). Additionally or alternatively, the composite object may in embodiments comprise one or more metal parts (attached to the (same) 3D printed part).

The metal part may in embodiments function as a receiver item for the 3D printed part. In such case, the receiver item may be part of the composite object. The receiver item will be further described below. Alternatively, the metal part may be positioned on a receiver item prior to and/or during the 3D printing. In such case, the receiver item may not be part of the composite object. The metal part may especially be solderable. In embodiments, the metal of the metal part may be selected from the group comprising copper, zinc, aluminum, silver, gold, tin, nickel titanium, tungsten, an alloy of two or more of the afore-mentioned, such as e.g. a copper tungsten alloy, or a copper zinc alloy, such as brass. In specific embodiments, the metal of the metal part may be selected from the group comprising copper, zinc, silver, gold, tin, nickel, an alloy of two or more of the afore-mentioned, such as e.g. a copper alloy, such as brass. The metal part may in embodiments comprise a metallic coating. In embodiments at least part of the metal part comprises a metallic material.

Especially, the 3D printing stage may comprise depositing 3D printable material on the metal of the metal part. The 3D printing stage may in embodiments be indicated as 3D printing process.

In specific embodiments, the metal may comprise an electrical component. The electrical component may in embodiments comprise a copper wire. In further embodiments, the metal part may function as an electrically conductive track. Additionally or alternatively, the metal part may function as an electromagnetic shield. In alternative embodiments, the metal part may function as a heatsink or heat spreader.

As indicated above, the invention may provide a method for producing a composite object comprising a 3D printed part adhering to a metal part. The 3D printed part may be produced by means of fused deposition modelling. The 3D printed part may comprise one or more layers of 3D printed material. Especially, the 3D printed part may comprise a plurality of layers of 3D printed material. One or more of these layers may comprise at least a part (“layer part”) with a first 3D printed material that comprises thermoplastic material and metal particles.

Especially, the method may comprise layer-wise depositing (an extrudate comprising) a 3D printable material. Hence, a stack of layers may be provided. The method may comprise using a 3D printer comprising a printer nozzle. The 3D printing stage may comprise guiding the 3D printable material through the printer nozzle. Especially, the 3D printable material may be extruded through the printer nozzle. During operation, the printer nozzle may have a nozzle temperature T_{N}, during at least part of the 3D printing stage. In embodiments, the method may comprise controlling the nozzle temperature T_{N}. To this end, a control system may be applied (see also below).

As indicated above, the 3D printing stage may at least comprise a first 3D printing stage. The first 3D printing stage especially comprises depositing the first 3D printable material on the metal part. Hence, at least part of the 3D printing stage may comprise the first 3D printing stage. At least part of one of the layers, especially a part in contact with the metal part, may thus comprise metal particles. Note that other parts may have different compositions.

The 3D printable material may comprise thermoplastic material. Especially, as indicated above, the first 3D printable material may comprise a (first) thermoplastic material. Depending on the thermoplastic material, it has a transition temperature T_{G} or a melting temperature T_{M}, or both, which are further discussed below. Hence, the thermoplastic material may have a change temperature T_{C} selected from a glass transition temperature T_{G} and a melting temperature T_{M}.

As indicated above, the first 3D printable material may further comprise metal particles. The metal particles may especially be metal comprising particles. Especially, the metal particles comprise at least a metal. Hence, the metal particles may comprise metallic material. The (metal in the) metal particles may melt during the 3D printing stage (especially in the printer nozzle) and adhere to the metal part of the composite object. The metal of the metal particles has a melting temperature T_{P}. The metal (comprising) particles may in embodiments further comprise a melting point depressant. Melting point depression refers to the phenomenon of reduction of the melting point of a material by incorporation of impurities in its crystal lattice. In embodiments, the metal particles may further comprise a thermoplastic material. Such thermoplastic material may improve adhesion of the metal particles to the thermoplastic material of the 3D printed material. Further embodiments of the metal and metal particles are described below.

As indicated above, the method may comprise controlling the nozzle temperature T_{N}. In embodiments of the 3D printing stage, T_{N}>T_{C}. In this way, the thermoplastic material may have a viscosity suitable for extrusion. Especially T_{N}−T_{C}≥50° C., such as T_{N}−T_{C}≥75° C., like T_{N}−T_{C}≥100° C., especially T_{N}−T_{C}≥125° C. In additional or alternative embodiments T_{N}−T_{C}≤500° C., such as T_{N}−T_{C}≤300° C., like T_{N}−T_{C}≤200° C. As indicated above, the thermoplastic material may have a change temperature T_{C} selected from a glass transition temperature T_{G} and a melting temperature T_{M}. Hence, in embodiments T_{N}−T_{G}≥50° C., such as T_{N}−T_{G}≥75° C., like T_{N}−T_{G}≥100° C., especially T_{N}−T_{G}≥125° C. Or in alternative embodiments T_{N}−T_{M}≥50° C., such as T_{N}−T_{M}≥75° C., like T_{N}−T_{M}≥100° C., especially T_{N}−T_{M}≥125° C. In further embodiments T_{N}−T_{G}≤500° C., such as T_{N}−T_{G}≤300° C., like T_{N}−T_{G}≤200° C. Or in alternative embodiments T_{N}−T_{M}≤500° C., such as T_{N}−T_{M}≤300° C., like T_{N}−T_{M}≤200° C. Such differences between nozzle temperature T_{N} and change temperature T_{C} may provide a relatively low viscosity of the thermoplastic material which may be beneficial for the extrusion and/or may improve adhesion between layers.

Additionally or alternatively, T_{N}>T_{P} during the 3D printing stage. In this way, the metal particles may (partially) melt. Especially T_{N}−T_{P}≥50° C., such as T_{N}−T_{P}≥75° C., like T_{N}−T_{P}≥100° C., especially T_{N}−T_{P}≥125° C. Additionally or alternatively, T_{N}−T_{P}≤300° C., such as T_{N}−T_{P}≤200° C., like T_{N}−T_{P}≤100° C. In specific embodiments, T_{N}−T_{P}≤50° C. After exiting the nozzle, the metal particles may cool down as the surrounding temperature may be below the nozzle temperature T_{N}. Therefore, it may be beneficial to use a relatively high nozzle temperature T_{N} such that at least part of the metal particles may remain melted during deposition on the metal part.

Additionally or alternatively, the method may comprise selecting the thermoplastic material and metal such that their corresponding change temperature T_{C} and melting temperature T_{P} may in embodiments be related as following: |T_{C}−T_{P}|≤60° C., such as |T_{C}−T_{P}|≤50° C., like |T_{C}−T_{P}|≤30° C., such as |T_{C}−T_{P}|≤20° C. In this way, change temperature T_{C} and melting temperature T_{P} may be in the same range. This may facilitate handling of the 3D printable material, such as for mixing and/or flowing. As indicated above, the thermoplastic material may have a change temperature T_{C} selected from a glass transition temperature T_{G} and a melting temperature T_{M}. Hence, in embodiments |T_{G}−T_{P}|≤60° C., such as |T_{G}−T_{P}|≤50° C., like |T_{G}−T_{P}|≤30° C., such as |T_{G}−T_{P}|≤20° C. Or in alternative embodiments |T_{M.}−T_{P}|≤60° C., such as |T_{M}−T_{P}|≤50° C., like |T_{M}−T_{P}|≤30° C., such as |T_{M}−T_{P}|≤20° C. Hence, in specific embodiments |T_{C}−T_{P}|≤50° C., T_{N}−T_{C}≥50° C., and T_{N}−T_{P}≥50° C.

The method may further comprise selecting the thermoplastic material and metal such that their corresponding change temperature T_{C} and melting temperature T_{P} may in embodiments be related as following: in specific embodiments T_{C}<T_{P}. Especially T_{G}<T_{P} and/or T_{M}<T_{P}. In such case, the metal particles may be more stable in the melted thermoplastic material. In such embodiments, the metal may comprise a normal solder, e.g. an alloy of copper and zinc or an alloy of copper and silver. In alternative embodiments T_{C}>T_{P}. Especially T_{G}≥T_{P} and/or T_{M}≥T_{P} In such case, the metal particles may have a longer timeframe to adhere to the metal part. In such embodiments, the metal may comprise a soft solder, e.g. an alloy of tin and lead or an alloy of tin, silver and copper. Suitable metal particles may in embodiments comprise one or more of Cu, Zn, Ag, Sn, Pb, Bi, Ga, In, and Ga, though other materials are herein not excluded. Especially, the metal particles may comprise alloys. In specific embodiments, the metal of the metal particles comprises one or more of indium and tin. “One or more of indium and tin” may refer to particles comprising indium and other particles comprising tin, but may also refer to particles comprising both indium and tin, such as In—Sn alloys like 91In 9Sn and like 90In 10Sn. In embodiments, the metal of the metal particles may comprise indium. In alternative embodiments, the metal of the metal particles may comprise tin. In specific embodiments, the metal of the metal particles may comprise an alloy of indium and tin. Two or more metal particles may comprise the same composition and/or or two or more metal particles may comprise different compositions.

Additionally or alternatively, the method may comprise selecting the thermoplastic material such that the change temperature T_{C} is in the range of 120-350° C., such as 150-300° C., like 180-250° C. Hence, in specific embodiments, the change temperature T_{C} may be selected from the range of 150-300° C.

As indicated above, the method may comprise controlling the nozzle temperature T_{N}. Additionally or alternatively, the method may comprise controlling the extrusion rate VE. Especially the nozzle temperature T_{N} and extrusion rate VE may be coordinated such that at least part of the metal in the metal particles may melt, such as at least 30 wt %, like 50 wt %, especially 70 wt %. Hence, in embodiments, the method may comprise controlling during the first 3D printing stage an extrusion rate VE and the nozzle temperature T_{N} to melt at least 50 wt % of the metal in the first 3D printable material (within the nozzle). Especially, the method may comprise controlling during the first 3D printing stage an extrusion rate VE and the nozzle temperature T_{N} in relation to particle dimensions of the metal particles. An extrusion rate VE (in relation to a specific nozzle temperature T_{N}) that may work for small metal particles may be less suitable for larger particles as the larger metal particles might not melt under the same conditions. Larger metal particles may e.g. require more energy (lower extrusion rate VE and/or higher nozzle temperature T_{N}) to melt.

As indicated above, the metal (comprising) particles may in embodiments further comprise a melting point depressant, such as e.g. lead. In this way, melting temperature T_{P} may be further controlled and optionally tuned in relation to a change temperature T_{C} and/or nozzle temperature T_{N}.

In this way, 3D printable material may be deposited on the metal part with molten metal. This molten metal may form a solder, which is soldered to the metal part but which is also partly incorporated in the 3D printed material. In this way, the composite object can be formed with pieces of metal extending into the 3D printed material and connected to the metal part.

As soon as the connection has been formed, it is not necessary to further 3D print layers on the already 3D printed layer based on 3D printable material comprising metal particles, though this is herein also not excluded. Hence, returning to the 3D printing stage, the 3D printing stage may in embodiments comprise a second 3D printing stage. Especially, the second 3D printing stage may comprise depositing a second layer of (second) 3D printable material. The second layer may especially comprise second 3D printed material. In embodiments, the second 3D printing stage may comprise depositing a second layer of second 3D printable material on a previously deposited layer, i.e. a first layer, see also below. In specific embodiments, the 3D printable material of the second 3D printing stage may comprise second 3D printable material. The second 3D printable material may especially comprise a lower content of metal than the first 3D printable material. In such embodiments, the second 3D printable material may especially comprise fewer metal particles and/or smaller metal particles. The second 3D printable material may in specific embodiments comprise no metal particles. As indicated above, the metal in the metal particles in the first 3D printable material may especially improve adhesion of a first layer to a metal part. As a previously deposited (first) layer may comprise a substantial amount (see below) of thermoplastic material, the second 3D printable (and printed) material may adhere to the first layer. Hence, in specific embodiments, the 3D printing stage comprises a second 3D printing stage comprising: depositing the 3D printable material on a previously deposited layer, wherein the 3D printable material comprises second 3D printable material comprising a lower content of metal than the first 3D printable material or comprising no metal particles. The term “second layer” may refer to any subsequent layer on the layer directly printed on the metal part.

As indicated above, the metal particles may improve adhesion of 3D printed material to the metal part. In embodiments, the adhesion may be influenced by one or more parameters. These parameters may e.g. comprise shape of the metal particles, size of the metal particles, concentration of the metal particles, dimensions of the 3D printed layer, use of a core-shell layer, dimensions of the core-shell layer, material properties of the 3D printable/printed material, material properties of the metal particle. The metal particles may especially adhere to the metal part and form connecting (metal) particles. For metal particles in the first 3D printable material to adhere to the metal part of the composite object, the metal particles need to be in contact with the metal part. In embodiments, more metal particles may be brought in contact with the metal part by flattening the layer of 3D printed material. The layer may in embodiments be flattened by exerting a downforce on the layer by the printer nozzle. In this way, metal particles may be brought in contact with the metal part. In embodiments, a metal particle that forms an adhesion with the metal part, may be referred to as a connecting particle. Such connecting particle may in embodiments be deformed, such as flattened, during the 3D printing stage.

Especially, the (3D printed) layer may have a layer height H. In embodiments, the particle sizes may be defined by smallest rectangular prisms circumscribing the respective particles, wherein such rectangular prism has a length L1, a width L2 and a height L3, wherein L1≥L2≥L3. In embodiments wherein the metal particles are spherical or cubic L1=L2=L3. In alternative embodiments, at least one dimension may be different and hence at least one aspect ratio may be greater than 1, see below. Especially, in embodiments H<L3. In such embodiments, the smallest dimension of the metal particles may be larger than the layer height. In this way, more metal particles may adhere to the metal part. Hence, in specific embodiments, the layer has a layer height H, wherein the metal particles have particle dimensions defined by smallest rectangular prisms circumscribing the respective metal particles, wherein each rectangular prism has a length L1, a width L2 and a height L3, wherein L1≥L2≥L3, and wherein H<L3.

In embodiments, the method may comprise a first 3D printing stage and a second 3D printing stage. Alternating between stages may in embodiments comprise alternating between printer heads. In such embodiments, the method comprises using a 3D printer comprising a plurality of printer heads. Especially, a first printer head may be functionally coupled to a source of the first 3D printable material. Additionally or alternatively, a second printer head may be functionally coupled to a source of the second 3D printable material.

Additionally or alternatively, the method may comprise using a 3D printer comprising a core-shell nozzle. Especially, the core-shell nozzle may comprise a core nozzle and a shell nozzle. In specific embodiments, the shell nozzle may at least partly enclose the core nozzle. The method may in embodiments further comprise guiding during the 3D printing stage (i) the first 3D printable material through the shell nozzle or the core nozzle and (ii) the second 3D printable material, comprising a lower content of metal than the first 3D printable material or comprising no metal particles, through the other one of the shell nozzle and the core nozzle. Especially, by only extruding 3D printable material through one nozzle at a time, a layer may be provided comprising only first 3D printed material or only second 3D printed material. In this way, alternating between the first 3D printing stage and the second 3D printing stage may be relatively easy. This will be further discussed below. Hence, in specific embodiments, the method comprises: using a 3D printer comprising a core-shell nozzle, wherein the core-shell nozzle comprises a core nozzle and a shell nozzle; wherein the method further comprises guiding during the 3D printing stage (i) the first 3D printable material through the shell nozzle or the core nozzle and (ii) the second 3D printable material, comprising a lower content of metal than the first 3D printable material or comprising no metal particles, through the other one of the shell nozzle and the core nozzle. Therefore, in embodiments a core or a shell of a core-shell nozzle may be functionally coupled to a source of the first 3D printable material. Additionally or alternatively, another one of the core and the shell of the core-shell nozzle may be functionally coupled to a source of the second 3D printable material.

As indicated above, alternating between the first 3D printing stage and the second 3D printing stage may in embodiments be achieved by only extruding 3D printable material through one nozzle at a time. Especially, the method may comprise guiding during the first 3D printing stage only first 3D printable material through the core-shell nozzle. In specific embodiments, the method may comprise guiding during the first 3D printing stage only first 3D printable and no second 3D printable material through the core-shell nozzle. Additionally or alternatively, the method may comprise guiding during the second 3D printing stage only second 3D printable through the core-shell nozzle. Especially, the method may comprise guiding during the second 3D printing stage no first 3D printable material through the core-shell nozzle. Hence, in specific embodiments the method may comprise guiding during the second 3D printing stage only second 3D printable material through the core-shell nozzle.

In further embodiments, the core-shell nozzle may be used for reducing the amount of metal particles necessary for adhesion. Metal particles that are embedded in a central part of the first 3D printed material may not be in contact with the metal part and hence may not improve adhesion of the first layer to the metal part. Therefore, in embodiments a core of a first layer may in embodiments comprise second 3D printable material. In this way, in embodiments a lower number of metal particles may be used to obtain a similar level of adhesion. Therefore, the method may comprise using a 3D printer comprising a core-shell nozzle. Especially, the core-shell nozzle may comprise a core nozzle and a shell nozzle. The shell nozzle may in embodiments at least partly enclose the core nozzle. Especially, the method may further comprise guiding during the 3D printing stage the first 3D printable material through the shell nozzle. Additionally or alternatively, the method may further comprise guiding during the 3D printing stage the second 3D printable material through the core nozzle. Especially, the second 3D printable material may comprise a lower content of metal than the first 3D printable material or may comprise no metal particles. Hence, in specific embodiments, the method comprises: using a 3D printer comprising a core-shell nozzle, wherein the core-shell nozzle comprises a core nozzle and a shell nozzle; wherein the method further comprises guiding during the 3D printing stage (i) the first 3D printable material through the shell nozzle and (ii) the second 3D printable material, comprising a lower content of metal than the first 3D printable material or comprising no metal particles, through the core nozzle. This may in embodiments provide a core-shell layer. Especially, the core-shell layer may comprise a core and a shell, wherein the shell may comprise first 3D printed material and wherein the core may comprise second 3D printed material. Especially the second printed material may comprise a lower content of metal than the first 3D printed material or may comprise no metal particles. Hence, in such embodiment, the core may comprise a lower content of metal than the shell. This may in embodiments reduce material costs as lower content of metal may be incorporated in the 3D printed part.

Such core-shell layer may in alternative embodiments be obtained by providing a core-shell filament to the printer head. Embodiments of the core-shell layer obtained by 3D printing using a core-shell nozzle may also apply to the core-shell layer obtained by 3D printing using a core-shell nozzle. The core-shell filament is discussed below.

Additionally, this may in embodiments provide in a first 3D printing stage a layer comprising first 3D printed material and in a second 3D printing stage a layer comprising second 3D printed material. As indicated above, using a core-shell nozzle may facilitate alternating between a first 3D printing stage and a second 3D printing stage.

The (thus obtained) core-shell layer may in embodiments have a core height H1 and a shell height H2. In specific embodiments, H2<L3. In such embodiment, the smallest dimension of the particles may be larger than the shell height. In this way, more metal particles may be in contact with the metal part.

In specific embodiments, the second thermoplastic material (especially the thermoplastic material in the core) may have a higher stiffness than the first thermoplastic material (especially the thermoplastic material in the shell). The core material may in embodiments comprise a solid such as a metal or polymeric fiber. In this way, more metal particles may in embodiments be brought in contact with the metal part as they may be more likely to be pushed out of the layer than into the core. Hence, in specific embodiments, the core-shell layer has a shell height H2, wherein the metal particles have particle dimensions defined by smallest rectangular prisms circumscribing the respective metal particles, wherein each rectangular prism has a length L1, a width L2 and a height L3, wherein L1≥L2≥L3, and wherein H2<L3.

Returning to the metal part, adhesion of the 3D printed part may in embodiments be improved by a pretreatment of the metal part. Therefore, in embodiments, the method may comprise executing a pretreatment stage preceding the 3D printing stage. In embodiments, the pretreatment stage may comprise cleaning the metal part.

Additionally or alternatively, the pretreatment stage may comprise roughening of the metal part i.e. the surface roughness of the metal part may be increased. The surface roughness may be defined by the root mean square (RMS) roughness parameter. The root mean square roughness may be obtained by squaring each height value in the dataset, followed by taking the square root of the mean. In specific embodiments, the method may comprise increasing the RMS roughness parameter by at least twofold, like at least fivefold, such as at least eightfold. For instance, the surface of the metal part may be provided with a RMS selected from the range of 1-100 μm, such as at least 2 μm, like up to about 90 μm.

Additionally or alternatively, the pretreatment stage may comprise providing one or more indentations in the metal part. Such indention may in embodiments have a surface area in the range of 1000 μm²-1 mm², like in the range of 2000 μm²-0.5 mm². The height of an indentation may in embodiments be in the range of 100 μm-1000 μm. Additionally or alternatively, the pretreatment stage may comprise providing one or more metal part protrusions to the metal part. Such protrusion may in embodiments have a surface area in the range of 1000 μm²-1 mm², like in the range of 2000 μm²-0.5 mm². The height of a protrusion may in embodiments be in the range of 100 μm-1000 μm. Cleaning the metal part may in embodiments include one or more of removal of an oxidation layer and removal of non-metal pollution. Roughening of the metal part may in embodiments increase the area of contact between the 3D printed part and the metal part. Providing indentations and/or protrusions to the metal part may also increase the area of contact between the 3D printed part and the metal part. Hence, in specific embodiments, the method comprises: executing a pretreatment stage preceding the 3D printing stage, wherein the pretreatment stage comprises one or more of (i) cleaning the metal part, (ii) roughening of the metal part, (iii) providing one or more indentations in the metal part, and (iv) providing one or more metal part protrusions to the metal part.

As indicated above, the metal particles may (partially) melt and adhere to the metal part. Therefore, in embodiments T_{N}>T_{P} during the 3D printing stage. Especially (partially) molten particles may adhere to the metal part. In embodiments, the particles may cool down after extrusion, prior to depositing. This may in embodiments cause (partial) solidification of the particles. Therefore, in embodiments, the metal part may (temporarily) be heated to a temperature higher than T_{P} and/or the nozzle temperature may be relatively high (see also above). In this way, the particles may adhere better to the metal part.

As indicated above, the change temperature T_{C} of the thermoplastic material and melting temperature T_{P} of the metal may be in the same range.

Returning to the metal particles, the shape of the metal particles may influence the number of metal particles in contact with the metal part. In embodiments, the metal particles may be spherical, cubic, prismoid, flakes, or irregularly shaped. Hence, in specific embodiments the particles may comprise a membered body (with an “amoeba-like” shape). Therefore, the particles may comprise extended appendages. Hence, the metal particles may comprise a plurality of extensions. Such extensions may in embodiments substantially increase the total dimensions of the particle while at the same time keeping an increase in the total amount of metal to a minimum. In this way, more metal particles may be in contact with the metal part and may form connecting particles. In (alternative) embodiments, the metal particles may be substantially spherical. Spherical metal particles may comprise a relatively large amount of metal relative to their outer dimensions. Hence, spherical metal particles may be relatively small compared to other shapes of metal particles. Small metal particles (and hence spherical particles) may be less prone to form aggregates during the 3D printing process. In specific embodiments, the metal particles may be substantially spherical, and the first 3D printable material comprises the metal particles at a concentration selected from the range of 10-50 vol. %. The concentration of the metal particles is further discussed below.

Particle sizes are especially selected such that the metal particles can pass the printer nozzle without clog formation. Substantially elongated metal particles may align with the extrudate and layer and may therefore be less likely to contact the metal part. As indicated above, in embodiments, the particle sizes are defined by smallest rectangular prisms circumscribing the respective particles, wherein such rectangular prism has a length L1, a width L2 and a height L3, wherein L1≥L2≥L3. In embodiments, length L1 is in the range from 30-3000 μm, especially in the range from 100-2000 μm, especially in the range from 250-1500 μm, more especially in the range from 500-1000 μm. Smaller particles may melt faster and/or at a lower nozzle temperature. Larger particles may form larger adhesions with the metal part. Such rectangular prim has a first aspect ratio AR1=L1/L2, a second aspect ratio is AR2=L1/L3, and a third aspect ratio is AR3=L2/L3. In embodiments, AR1 and AR2 are individually selected from the range of 1-10000, especially in the range of 2-1000, more especially in the range of 5-500, such as greater than 5. In specific embodiments, AR1 may be at least 5. Additionally or alternatively, AR2 may be at least 5.

Hence, in specific embodiments, the (metal) particles have particle dimensions defined by smallest rectangular prisms circumscribing the respective metal particles, wherein each rectangular prism has a length L1, a width L2 and a height L3, wherein L1≥L2≥L3, wherein the length L1 is selected from the range from 30-3000 μm wherein a first aspect ratio is AR1=L1/L3, wherein a second aspect ratio is AR2=L2/L3, wherein the aspect ratios AR1 and AR2 are individually selected from the range of 1-10000, and wherein at least one of AR1 and AR2 is at least 5. In such embodiments, the metal particles may comprise elongated metal particles. Elongated metal particles may especially align with the layer. Elongated metal particles may have a relatively large contact area with the metal part. In embodiments, elongated particles may comprise one or more of needle-shaped particles and flakes. In (other) embodiments, at least one of AR1 and AR2 is at maximum 5.

Metal particles may in other embodiments have a shape of a short coiled wire.

In alternative embodiments, particles with aspect ratios around about 1 may be selected. In such embodiments, the metal particles may comprise one or more of spherical metal particles and cubic metal particles. Metal particles having a low aspect ratio may in embodiments be more exposed to the metal part. Therefore, in embodiments the aspect ratios AR1 and AR2 may be individually selected from the range of 1-5, such 1-2. Hence, in specific embodiments, the metal particles have particle dimensions defined by smallest rectangular prisms circumscribing the respective metal particles, wherein each rectangular prism has a length L1, a width L2 and a height L3, wherein L1≥L2≥L3, wherein the length L1 is selected from the range from 30-3000 μm, wherein a first aspect ratio is AR1=L1/L3, wherein a second aspect ratio is AR2=L2/L3, wherein the aspect ratios are individually selected from the range of 1-2.

Particle sizes (particles in general, hence including metal particles) may be determined with methods known in the art, like one or more of optical microscopy, SEM and TEM. Dimensions may be number averaged, as known in the art. Further, the aspect ratios indicated above may refer to a plurality of metal particles having different aspect ratios. Hence, the metal particles may be substantially identical, but the metal particles may also mutually differ, such as two or more subsets of metal particles, wherein within the subsets the metal particles are substantially identical. The metal particles may have a unimodal particle size distribution or a polymodal size distribution.

The metal particles may thus mutually differ. For instance, the metal particles may have a distribution of the sizes of one or more of the particle length, the particle height, and an intermediate length. Therefore, in embodiments in average, the metal particles will have dimensions as described herein. For instance, at least 50 wt % of the metal particles may comply with the herein indicated dimensions (including ratios), such as at least 75 wt %, like at least 85 wt %. In alternative embodiments, at least 50% of the total number of metal particles may comply with the herein indicated dimensions (including ratios), such as at least 75%, like at least 85%.

Embodiments of the shape and/or dimensions of metal particles may especially refer to the shape and/or dimensions of metal particles prior to the 3D printing stage.

As indicated above, two or more metal particles may comprise the same composition and/or two or more metal particles may comprise different compositions. In embodiments, the metal particles may be a first metal particle which may have a first melting temperature T_{P1} and which may (partially) melt during the 3D printing stage. Hence, all embodiments described for metal particles in general, may apply to the first metal particle.

Hence, in embodiments T_{N}>T_{P1} during the 3D printing stage. Especially T_{N}−T_{P1}≥50° C., such as T_{N}−T_{P1}>75° C., like T_{N}−T_{P1}≥100° C., especially T_{N}−T_{P1}≥125° C. Additionally or alternatively, T_{N}−T_{P1}≤300° C., such as T_{N}−T_{P1}≤200° C., like T_{N}−T_{P1}≤100° C., especially T_{N}−T_{P1}≤50° C.

In further embodiments, |T_{C}−T_{P1}|≤60° C., such as |T_{C}−T_{P1}|≤50° C., like |T_{C}−T1_{P}|≤30° C., such as |T_{C}−T_{P1}|≤20° C. Hence, in embodiments |T_{G}−T_{P1}|≤60° C., such as |T_{G}−T_{P1}|≤50° C., like |T_{G}−T_{P1}|≤30° C., such as |T_{G}−T_{P1}|≤20° C. Or in alternative embodiments |T_{M.}−T_{P1}|≤60° C., such as |T_{M}−T_{P1}|≤50° C., like |T_{M}−T1_{P}|≤30° C., such as |T_{M}−T_{P1}|≤20° C.

In further embodiments, the method may comprise using a second metal particle which may not melt during the 3D printing stage. Especially, embodiments regarding shape and dimensions for metal particles, may apply to the second metal particle. In such embodiments, the 3D printable material may comprise (first) metal particles and second metal particles.

The second metal particle may have a second melting temperature T_{P2}. In embodiments, T_{P2}>T_{P1}. Especially, T_{P2}−T_{P1}>20° C., like T_{P2}−T_{P1}>50° C., such as T_{P2}−T_{P1}>100° C. In yet further embodiments, T_{P2}−T_{P1}>200° C., like T_{P2}−T_{P1}>500° C., such as T_{P2}−T_{P1}>800° C. Especially, T_{P2}>T_{C}. In specific embodiments, T_{P2}−T_{C}≥50° C., such as T_{P2}−T_{C}≥75° C., like T_{P2}−T_{C}≥100° C., especially T_{P2}−T_{C}≥125° C. In yet further embodiments, T_{P2}−T_{C}≥200° C., like T_{P2}−T_{C}≥500° C., such as T_{P2}−T_{C}≥800° C. Especially, wherein T_{P2}>T_{N}. More especially, T_{P2}−T_{N}≥50° C., such as T_{P2}−T_{N}≥75° C., like T_{P2}−T_{N}≥100° C., especially T_{P2}−T_{N}≥125° C. In yet further embodiments, T_{P2}−T_{N}≥200° C., like T_{P2}−T_{N}≥500° C., such as T_{P2}−T_{N}≥800° C.

In this way, a higher percentage of (first) metal particles may melt compared to a percentage of second metal particles. This may provide a combination of melted and non-melted particles in the 3D printable material. Especially, a part of the metal particles may (partially) melt during extrusion and another part of the metal particles may not melt during extrusion. In embodiments, a non-melted metal particle may retain its dimension and/or shape from prior to the 3D printing stage. The second metal particle may in embodiments be connected to another second metal particle or to the metal part by a (partially) melted first metal particle. The second metal particle may function as an anchor in the thermoplastic material. In this way, adhesion may be further improved. The second metal particle may in embodiments comprise one or more of copper (e.g. cuttings of a copper wire) and brass.

Hence, in specific embodiments, the metal particles may be first metal particles. In specific embodiments, the method may further comprise second metal particles, wherein the (first) metal particles have a first melting temperature T_{P1} and the second metal particles have a second melting temperature T_{P2}, wherein T_{N}>T_{P1} and wherein T_{N}<T_{P2}. In this way, improved interaction and anchoring with the polymer may be obtained.

In embodiments, the (first) metal particles may be substantially spherical. Additionally or alternatively, the second metal particles may comprise extensions.

The metal particles may in embodiments be comprised by the first 3D printable material. Especially, the first 3D printable material may comprise the metal particles at a concentration selected from the range of 5-60 vol. %, like 10-50 vol. % such as 15-40 vol. %, like 5-20 vol. %. In alternative embodiments, the first 3D printable material may comprise the metal particles at a concentration selected from the range of 35-50 vol. %. Hence, in specific embodiments the first 3D printable material comprises the metal particles at a concentration selected from the range of 10-50 vol. %. In further embodiments, the first 3D printable material may comprise the second metal particles at a concentration selected from the range of 5-60 vol. %, like 10-50 vol. % such as 15-40 vol. %, like 5-20 vol. %. Smaller values than about 10 vol. %, such as smaller than 5 vol. %, may not have the desired adhesive effect, larger values than about 60 vol. %, such as larger than about 50 vol. % may become very difficult to print the first 3D printable material and/or the metal particles (or molten metal particles) may form aggregates. In embodiments, the remainder of the volume may be polymeric material, and optionally other fillers (see also below).

When the 3D printable material comprises both the (first) metal particles and the second metal particles, the combined concentration may in embodiments be selected from the range of 5-60 vol. %, like 10-50 vol. % such as 15-40 vol. %, like 5-20 vol. %. Hence, in specific embodiments the first 3D printable material may comprise the metal particles and the second metal particles at a total concentration selected from the range of 10-50 vol. %.

In specific embodiments, the second metal particles may have at least one aspect ratio of at least 5, such as at least 10.

In specific embodiments, first particles may be provided associated to the second particles. For instance, to a metallic thread as second particle first metal particles may be associated. Such associated particulate material may be combined with thermoplastic material, to provide the 3D printable material.

Hence, in embodiments the first particles may have a different shape than the second particles, with especially the second particles having substantially larger aspect ratios. For instance, a ratio of the aspect ratios of the first particles to the second particles may be smaller than 0.5, such as smaller than 0.1, like even smaller than 0.05.

When referring to the concentration of the particles during deposition of the filaments or after deposition of the filaments, the concentration especially refers to at least part of such filament, or at least part of the deposited layer. Hence, the concentration of the particles may vary over the length of the filament or may vary over a length of a layer, or differ between layers. It is even possible that there are layers without particles and layers with particles. The smallest (integral) volume for which the concentration applies is especially at least 1 cm³, such as at least 2 cm³, like at least 5 cm³. Of course, this may be a relative extended volume, as the height and width of the layers are in general relatively small.

As indicated above, the method comprises depositing during a printing stage 3D printable material. Herein, the term “3D printable material” refers to the material to be deposited or printed, and the term “3D printed material” refers to the material that is obtained after deposition. These materials may be essentially the same, as the 3D printable material may especially refer to the material in a printer head or extruder at elevated temperature and the 3D printed material refers to the same material, but in a later stage when deposited. In embodiments, the 3D printable material may be printed as a filament and deposited as such. The 3D printable material may be provided as filament or may be formed into a filament. Hence, whatever starting materials are applied, a filament comprising 3D printable material may be provided by the printer head and 3D printed. The term “extrudate” may be used to define the 3D printable material downstream of the printer head, but not yet deposited. The latter may be indicated as “3D printed material”. In fact, the extrudate may be considered to comprises 3D printable material, as the material is not yet deposited. Upon deposition of the 3D printable material or extrudate, the material may thus be indicated as 3D printed material. Essentially, the materials may be the same material, as the thermoplastic material upstream of the printer head, downstream of the printer head, and when deposited, may essentially be the same material(s).

Herein, the term “3D printable material” may also be indicated as “printable material”. The term “polymeric material” may in embodiments refer to a blend of different polymers, but may in embodiments also refer to essentially a single polymer type with different polymer chain lengths. Hence, the terms “polymeric material” or “polymer” may refer to a single type of polymers but may also refer to a plurality of different polymers. The term “printable material” may refer to a single type of printable material but may also refer to a plurality of different printable materials. The term “printed material” may refer to a single type of printed material but may also refer to a plurality of different printed materials.

Hence, the term “3D printable material” may also refer to a combination of two or more materials. In general, these (polymeric) materials have a glass transition temperature T_{g} and/or a melting temperature Tₘ. The 3D printable material will be heated by the 3D printer before it leaves the nozzle to a temperature of at least the glass transition temperature, and in general at least the melting temperature. Hence, in a specific embodiment the 3D printable material comprises a thermoplastic polymer having a glass transition temperature (T_{g}) and/or a melting point (Tₘ), and the printer head action may comprise heating the 3D printable material above the glass transition and in embodiments above the melting temperature (especially when the thermoplastic polymer is a semi-crystalline polymer). In yet another embodiment, the 3D printable material comprises a (thermoplastic) polymer having a melting point (Tₘ), and the 3D printing stage may comprise heating the 3D printable material to be deposited on the receiver item to a temperature of at least the melting point. The glass transition temperature is in general not the same thing as the melting temperature. Melting is a transition which may occur in crystalline polymers. Melting may happen when the polymer chains fall out of their crystal structures, and become a disordered liquid. The glass transition may be a transition which happens to amorphous polymers; that is, polymers whose chains are not arranged in ordered crystals, but are just strewn around in any fashion, even though they are in the solid state. Polymers can be amorphous, essentially having a glass transition temperature and not a melting temperature or can be (semi) crystalline, in general having both a glass transition temperature and a melting temperature, with in general the latter being larger than the former. The glass temperature may e.g. be determined with differential scanning calorimetry. The melting point or melting temperature can also be determined with differential scanning calorimetry.

As indicated above, the invention may thus provide a method comprising providing a filament of 3D printable material and printing during a printing stage said 3D printable material on a substrate, to provide said 3D printed part.

It may also be desirable to provide a filament which can be used in the herein described method. Therefore, in a further aspect, the invention provides 3D printable material, especially a filament for producing a 3D printed part by means of fused deposition modelling for use in the herein described method. Especially, the filament may comprise first 3D printable material comprising a thermoplastic material and metal particles. In embodiments, the metal particles may be at least partly embedded in the thermoplastic material. Especially, the thermoplastic material has a change temperature T_{C} selected from a glass transition temperature T_{G} and a melting temperature T_{M}. Especially, metal of the metal particles has a melting temperature T_{P}. In embodiments |T_{C}−T_{P}|≤60° C., such as |T_{C}−T_{P}|≤50° C., like |T_{C}−T_{P}|≤30° C., such as |T_{C}−T_{P}|≤20° C. As indicated above, the thermoplastic material may have a change temperature T_{C} selected from a glass transition temperature T_{G} and a melting temperature T_{M}. Hence, in embodiments |T_{G}−T_{P}|≤60° C., such as |T_{G}−T_{P}|≤50° C., like |T_{G}−T_{P}|≤30° C., such as |T_{G}−T_{P}|≤20° C. Or in alternative embodiments |T_{M.}−T_{P}|≤60° C., such as |T_{M}−T_{P}|≤50° C., like |T_{M}−T_{P}|≤30° C., such as |T_{M}−T_{P}|≤20° C. Hence, in specific embodiments, the invention relates to a filament for producing a 3D printed part by means of fused deposition modelling, the filament comprising first 3D printable material comprising a thermoplastic material and metal particles, wherein the thermoplastic material has a change temperature T_{C} selected from a glass transition temperature T_{G} and a melting temperature T_{M}, wherein metal of the metal particles has a melting temperature T_{P}, wherein |T_{C}−T_{P}|≤50° C. In this way, the change temperature T_{C} and melting temperature T_{P} are in the same range. This may facilitate using such filament in the method of the invention.

The filament may have a thickness H_{F}. In embodiments 0.2≤L3/H_{F}≤1, such as 0.3≤L3/H_{F}≤1, e.g. 0.5≤L3/H_{F}≤1, like 0.6≤L3/H_{F}≤0.9. In other embodiments 0.2≤L3/H_{F}≤0.7, like 0.2≤L3/H_{F}≤0.6, such as 0.2≤L3/H_{F}≤0.5. In this way, having relatively large metal particles, more particles may be in contact with the metal part after depositing the filament according to the method of the invention.

Embodiments described above for the method may also apply to the filament. As indicated above for the method, the metal of the metal particles may in embodiments comprise one or more of indium and tin. In embodiments, T_{C}<T_{P}. In alternative embodiments T_{C}>T_{P}. Especially, the change temperature T_{C} may be in the range of 120-350° C., such as 150-300° C., like 180-250° C.

As described above, the first 3D printable material may comprise the metal particles at a concentration selected from the range of 5-60 vol. %, like 10-50 vol. % such as 15-40 vol. %. Hence, the filament may comprise the metal particles at a concentration selected from the range of 5-60 vol. %, like 10-50 vol. % such as 15-40 vol. %.

As described above for the method, the metal particles may in embodiments be a first metal particle which may have a first melting temperature T_{P1}. Especially, all embodiments described for metal particles, may apply to the first metal particle.

In further embodiments, the filament may comprise a second metal particle. Especially, embodiments regarding shape and dimensions for metal particles, may apply to the second metal particle.

The second metal particle may have a second melting temperature T_{P2}. In embodiments, T_{P2}>T_{P1}. Especially, T_{P2}−T_{P1}>20° C., like T_{P2}−T_{P1}>50° C., such as T_{P2}−T_{P1}>100° C. In yet further embodiments, T_{P2}−T_{P1}>200° C., like T_{P2}−T_{P1}>500° C., such as T_{P2}−T_{P1}>800° C. Especially, T_{P2}>T_{C}. In specific embodiments, T_{P2}−T_{C}≥50° C., such as T_{P2}−T_{C}≥75° C., like T_{P2}−T_{C}≥100° C., especially T_{P2}−T_{C}≥125° C. In yet further embodiments, T_{P2}−T_{C}≥200° C., like T_{P2}−T_{C}≥500° C., such as T_{P2}−T_{C}≥800° C.

In embodiments, the (first) metal particles may be substantially spherical. Additionally or alternatively, the second metal particles may comprise extensions.

In further embodiments, the filament may comprise a core-shell filament. Especially, the core-shell filament may comprise a core comprising second 3D printable material comprising a lower content of metal than the first 3D printable material. In specific embodiments, the core-shell filament may comprise a core comprising second 3D printable material comprising no metal particles. Especially, the core-shell filament may comprise a shell comprising the first 3D printable material. Hence, in specific embodiments, the core-shell filament may comprise: (i) a core comprising second 3D printable material comprising a lower content of metal than the first 3D printable material or comprising no metal particles, and (ii) a shell comprising the first 3D printable material. Such 3D printable material, especially such core-shell filament, can be printed in a standard fused deposition modeling 3D printer with a single nozzle.

Especially, the core-shell filament may have a shell thickness H_{2F}. In specific embodiments 0.5≤L3/H_{2F}≤1, like 0.6≤L3/H_{2F}≤0.9.

As indicated above, the shell of the core-shell filament may comprise the first 3D printable material. As indicated above, the first 3D printable material may comprise the metal particles. Hence, the shell of the core-shell filament may in embodiments comprise the metal particles. As indicated above, the core of the core-shell filament may comprise the second 3D printable material. Also indicated above, the second 3D printable material may comprise a lower content of metal than the first 3D printable material or comprise no metal particles. Hence, in specific embodiments, the core of the core-shell filament may comprise a lower content of metal than the first 3D printable material or no metal particles.

Materials that may especially qualify as 3D printable materials may be selected from the group consisting of metals, glasses, thermoplastic polymers, silicones, etc. Especially, the 3D printable material comprises a (thermoplastic) polymer selected from the group consisting of ABS (acrylonitrile butadiene styrene), Nylon (or polyamide), Acetate (or cellulose), PLA (poly lactic acid), terephthalate (such as PET polyethylene terephthalate), Acrylic (polymethylacrylate, Perspex, polymethylmethacrylate, PMMA), Polypropylene (or polypropene), Polycarbonate (PC), Polystyrene (PS), PE (such as expanded-high impact-Polythene (or polyethene), Low density (LDPE) High density (HDPE)), PVC (polyvinyl chloride) Polychloroethene, such as thermoplastic elastomer based on copolyester elastomers, polyurethane elastomers, polyamide elastomers polyolefine based elastomers, styrene based elastomers, etc., Optionally, the 3D printable material may comprise a 3D printable material selected from the group consisting of Urea formaldehyde, Polyester resin, Epoxy resin, Melamine formaldehyde, thermoplastic elastomer, etc., Optionally, the 3D printable material may comprise a 3D printable material selected from the group consisting of a polysulfone. Elastomers, especially thermoplastic elastomers, may especially be interesting as they are flexible and may help obtaining relatively more flexible filaments comprising the thermally conductive material. A thermoplastic elastomer may comprise one or more of styrenic block copolymers (TPS (TPE-s)), thermoplastic polyolefin elastomers (TPO (TPE-o)), thermoplastic vulcanizates (TPV (TPE-v or TPV)), thermoplastic polyurethanes (TPU (TPU)), thermoplastic copolyesters (TPC (TPE-E)), and thermoplastic polyamides (TPA (TPE-A)).

Suitable thermoplastic materials, such as also mentioned in WO2017/040893, may include one or more of polyacetals (e.g., polyoxyethylene and polyoxymethylene), poly(C₁₋₆ alkyl) acrylates, polyacrylamides, polyamides, (e.g., aliphatic polyamides, polyphthalamides, and polyaramides), polyamideimides, polyanhydrides, polyarylates, polyarylene ethers (e.g., polyphenylene ethers), polyarylene sulfides (e.g., polyphenylene sulfides), polyarylsulfones (e.g., polyphenylene sulfones), polybenzothiazoles, polybenzoxazoles, polycarbonates (including polycarbonate copolymers such as polycarbonate-siloxanes, polycarbonate-esters, and polycarbonate-ester-siloxanes), polyesters (e.g., polycarbonates, polyethylene terephthalates, polyethylene naphtholates, polybutylene terephthalates, polyarylates), and polyester copolymers such as polyester-ethers), polyetheretherketones, polyetherimides (including copolymers such as polyetherimide-siloxane copolymers), polyetherketoneketones, polyetherketones, polyethersulfones, polyimides (including copolymers such as polyimide-siloxane copolymers), poly(C₁₋₆ alkyl) methacrylates, polymethacrylamides, polynorbornenes (including copolymers containing norbornenyl units), polyolefins (e.g., polyethylenes, polypropylenes, polytetrafluoroethylenes, and their copolymers, for example ethylene-alpha-olefin copolymers), polyoxadiazoles, polyoxymethylenes, polyphthalides, polysilazanes, polysiloxanes, polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, polyvinyl alcohols, polyvinyl esters, polyvinyl ethers, polyvinyl halides, polyvinyl ketones, polyvinyl thioethers, polyvinylidene fluorides, or the like, or a combination comprising at least one of the foregoing thermoplastic polymers. Embodiments of polyamides may include, but are not limited to, synthetic linear polyamides, e.g., Nylon-6,6; Nylon-6,9; Nylon-6,10; Nylon-6, 12; Nylon-11; Nylon-12 and Nylon-4,6, preferably Nylon 6 and Nylon 6,6, or a combination comprising at least one of the foregoing. Polyurethanes that can be used include aliphatic, cycloaliphatic, aromatic, and polycyclic polyurethanes, including those described above. Also useful are poly(C₁₋₆ alkyl) acrylates and poly(C₁₋₆ alkyl) methacrylates, which include, for instance, polymers of methyl acrylate, ethyl acrylate, acrylamide, methacrylic acid, methyl methacrylate, n-butyl acrylate, and ethyl acrylate, etc. In embodiments, a polyolefine may include one or more of polyethylene, polypropylene, polybutylene, polymethylpentene (and co-polymers thereof), polynorbornene (and co-polymers thereof), poly 1-butene, poly(3-methylbutene), poly(4-methylpentene) and copolymers of ethylene with propylene, 1-butene, 1-hexene, 1-octene, 1-decene, 4-methyl-1-pentene and 1-octadecene.

In specific embodiments, the 3D printable material (and the 3D printed material) may comprise one or more of polycarbonate (PC), polyethylene (PE), high-density polyethylene (HDPE), polypropylene (PP), polyoxymethylene (POM), polyethylene naphthalate (PEN), styrene-acrylonitrile resin (SAN), polysulfone (PSU), polyphenylene sulfide (PPS), and semi-crystalline polytethylene terephthalate (PET), acrylonitrile butadiene styrene (ABS), poly(methyl methacrylate) (PMMA), polystyrene (PS), and styrene acrylic copolymers (SMMA).

The term 3D printable material is further also elucidated below, but may especially refer to a thermoplastic material, optionally including additives, to a volume percentage of at maximum about 60%, especially at maximum about 30 vol. %, such as at maximum 20 vol. % (of the additives relative to the total volume of the thermoplastic material and additives).

The printable material may thus in embodiments comprise two phases. The printable material may comprise a phase of printable polymeric material, especially thermoplastic material (see also below), which phase is especially an essentially continuous phase. In this continuous phase of thermoplastic material polymer additives such as one or more of antioxidant, heat stabilizer, light stabilizer, ultraviolet light stabilizer, ultraviolet light absorbing additive, near infrared light absorbing additive, infrared light absorbing additive, plasticizer, lubricant, release agent, antistatic agent, anti-fog agent, antimicrobial agent, colorant, laser marking additive, surface effect additive, radiation stabilizer, flame retardant, anti-drip agent may be present. The additive may have useful properties selected from optical properties, mechanical properties, electrical properties, thermal properties, and mechanical properties (see also above).

The printable material in embodiments may comprise particulate material, i.e. particles embedded in the printable polymeric material, which particles form a substantially discontinuous phase. The number of particles in the total mixture may especially not be larger than 60 vol. %, relative to the total volume of the printable material (including the (anisotropically conductive) particles) especially in applications for reducing thermal expansion coefficient. For optical and surface related effect number of particles in the total mixture is equal to or less than 20 vol. %, such as up to 10 vol. %, relative to the total volume of the printable material (including the particles). Hence, the 3D printable material may especially refer to a continuous phase of essentially thermoplastic material, wherein other materials, such as particles, may be embedded. Likewise, the 3D printed material especially refers to a continuous phase of essentially thermoplastic material, wherein other materials, such as particles, are embedded. The particles may comprise one or more additives as defined above. Hence, in embodiments the 3D printable materials may comprises particulate additives.

When using a core-shell nozzle, the 3D printable material provided to the core of the core-shell nozzle may be a filament comprising 3D printable material or may be particulate 3D printable material. Both type of feeds may be extruded via the core of the core-shell nozzle. The 3D printable material provided to a shell of the core-shell nozzle may be particulate 3D printable material. Such particulate 3D printable material (feed) may be extruded via the shell of the core-shell nozzle. When using a nozzle with a single opening, the 3D printable material provided to nozzle may be a filament comprising 3D printable material or may be particulate 3D printable material. Both type of feeds may be extruded via the nozzle.

The printable material may be printed on a receiver item. Especially, the receiver item can be the building platform or can be comprised by the building platform. The receiver item can also be heated during 3D printing. However, the receiver item may also be cooled during 3D printing.

The phrase “printing on a receiver item” and similar phrases include amongst others directly printing on the receiver item, or printing on a coating on the receiver item, or printing on 3D printed material earlier printed on the receiver item. The term “receiver item” may refer to a printing platform, a print bed, a substrate, a support, a build plate, or a building platform, etc., Instead of the term “receiver item” also the term “substrate” may be used. The phrase “printing on a receiver item” and similar phrases include amongst others also printing on a separate substrate on or comprised by a printing platform, a print bed, a support, a build plate, or a building platform, etc. . . . . Therefore, the phrase “printing on a substrate” and similar phrases include amongst others directly printing on the substrate, or printing on a coating on the substrate or printing on 3D printed material earlier printed on the substrate. Here below, further the term substrate is used, which may refer to a printing platform, a print bed, a substrate, a support, a build plate, or a building platform, etc., or a separate substrate thereon or comprised thereby.

Layer by layer printable material may be deposited, by which the 3D printed item may be generated (during the printing stage). The 3D printed item may show a characteristic ribbed structures (originating from the deposited filaments). However, it may also be possible that after a printing stage, a further stage is executed, such as a finalization stage. This stage may include removing the printed item from the receiver item and/or one or more post processing actions. One or more post processing actions may be executed before removing the printed item from the receiver item and/or one more post processing actions may be executed after removing the printed item from the receiver item. Post processing may include e.g. one or more of polishing, coating, adding a functional component, etc., Post-processing may include smoothening the ribbed structures, which may lead to an essentially smooth surface.

The herein described method provides a composite object comprising 3D printed parts. Hence, the invention also provides in a further aspect an composite object comprising a 3D printed part obtainable with the herein described method. In a further aspect an composite object comprising a 3D printed part obtainable with the herein described method is provided. Especially, the invention provides an composite object comprising a 3D printed part adhering to a metal part. Especially, the 3D printed part may comprise a layer of 3D printed material. In embodiments, at least part of the 3D printed material may comprise a first 3D printed material. The first 3D printed material may especially comprise a thermoplastic material and metal particles. The metal particles may especially be at least partly embedded in the thermoplastic material. In embodiments, the metal particles may comprise metal. Especially, at least part of the metal may be attached to the metal part (by connecting particles). In embodiments, at least part (like at least 0.25 cm², such as at least 1 cm², like at least 5 cm², such as at least 10 cm²) of the metal part comprises at least 1 connecting particle per 4 cm², like at least 1 connecting particle per 1 cm², such as at least 1 connecting particle per 0.25 cm². As indicated above, a connecting particle may comprise a metal particle that forms an adhesion with the metal part.

Hence, in specific embodiments the invention provides an composite object comprising a 3D printed part adhering to a metal part, wherein the 3D printed part comprises a layer of 3D printed material, wherein at least part of the 3D printed material comprises a first 3D printed material comprising a thermoplastic material and metal particles comprising metal, wherein at least part of the metal is attached to the metal part. In such a composite object, the metal particles may provide an improved adhesion to the metal part.

Especially, the 3D printed part may comprise one or more layers of 3D printed material. More especially, the 3D printed part may comprise a plurality of layers of 3D printed material. The 3D printed part may comprise two or more, like at least 5, such as at least 10, like in embodiments at least 20 layers of 3D printed material.

The 3D printed part may comprise a plurality of layers on top of each other, i.e. stacked layers. The width (thickness) and height of (individually 3D printed) layers may e.g. in embodiments be selected from the range of 100-5000 μm, such as 200-2500 μm, with the height in general being smaller than the width. For instance, the ratio of height and width may be equal to or smaller than 0.8, such as equal to or smaller than 0.6.

Layers may be core-shell layers or may consist of a single material. Within a layer, there may also be a change in composition, for instance when a core-shell printing process was applied and during the printing process it was changed from printing a first material (and not printing a second material) to printing a second material (and not printing the first material).

At least part of the 3D printed part may include a coating.

Some specific embodiments in relation to the composite object have already been elucidated above when discussing the method. Below, some specific embodiments in relation to the composite object (comprising the 3D printed part) are discussed in more detail.

As indicated above, the thermoplastic material has a change temperature T_{C} selected from a glass transition temperature T_{G} and a melting temperature T_{M}. Further, the metal of the metal particles has a melting temperature T_{P}. In embodiments, |T_{C}−T_{P}|≤60° C., such as |T_{C}−T_{P}|≤50° C., like |T_{C}−T_{P}|≤30° C., such as |T_{C}−T_{P}|≤20° C. As indicated above, the thermoplastic material may have a change temperature T_{C} selected from a glass transition temperature T_{G} and a melting temperature T_{M}. Hence, in embodiments |T_{G}−T_{P}|≤60° C., such as |T_{G}−T_{P}|≤50° C., like |T_{G}−T_{P}|≤30° C., such as |T_{G}−T_{P}|≤20° C. Or in alternative embodiments |T_{M.}−T_{P}|≤60° C., such as |T_{M}−T_{P}|≤50° C., like |T_{M}−T_{P}|≤30° C., such as |T_{M}−T_{P}|≤20° C. The metal may in embodiments comprise one or more of indium and tin. Hence, in specific embodiments, the thermoplastic material has a change temperature T_{C} selected from a glass transition temperature T_{G} and a melting temperature T_{M}, wherein the metal has a melting temperature T_{P}, wherein |T_{C}−T_{P}|≤50° C.; and wherein the metal may comprise one or more of indium and tin.

As indicated above for the method, in embodiments, T_{C}<T_{P}. Especially T_{G}<T_{P} and/or T_{M}<T_{P}. In alternative embodiments T_{C}>T_{P}. Especially T_{G}≥T_{P} and/or T_{M}≥T_{P}. Especially, the change temperature T_{C} may be in the range of 120-350° C., such as 150-300° C., like 180-250° C.

As described above, the first 3D printable material may comprise the metal particles at a concentration selected from the range of 5-60 vol. %, like 10-50 vol. % such as 15-40 vol. %. Hence, the first 3D printed material may comprise the metal particles at a concentration selected from the range of 5-60 vol. %, like 10-50 vol. % such as 15-40 vol. %. Hence, at least part of the 3D part may comprise the metal particles at a concentration selected from the range of 5-60 vol. %, like 10-50 vol. % such as 15-40 vol. %.

The composite object may especially comprise a first layer configured in contact with the metal part. At least a part of the first layer may, in embodiments, comprise the first 3D printed material. The first 3D printed material may especially comprise the metal attached to the metal part. The composite object may in embodiments further comprise a second layer. The second layer may especially comprise second 3D printed material comprising a lower content of metal than the first 3D printed material or comprising no metal. Hence, in specific embodiments, the composite object comprises (i) a first layer configured in contact with the metal part, wherein at least a part of the first layer comprises the first 3D printed material, and (ii) a second layer comprising second 3D printed material comprising a lower content of metal than the first 3D printed material or comprising no metal. The composite object may in embodiments further comprise (part of) a first layer configured not in contact with the metal part. Additionally or alternatively, the composite object may in embodiments further comprise (part of) a second layer configured in contact with the metal part.

As described above for the method, the metal particles may in embodiments be a first metal particle which may have a first melting temperature T_{P1}. Especially, all embodiments described for metal particles, may apply to the first metal particle.

In further embodiments, the composite object may comprise a second metal particle. Especially, embodiments regarding shape and dimensions for metal particles in general, may apply to the second metal particle.

The second metal particle may have a second melting temperature T_{P2}. In embodiments, T_{P2}>T_{P1}. Especially, T_{P2}−T_{P1}>20° C., like T_{P2}−T_{P1}>50° C., such as T_{P2}−T_{P1}>100° C. In yet further embodiments, T_{P2}−T_{P1}>200° C., like T_{P2}−T_{P1}>500° C., such as T_{P2}−T_{P1}>800° C. Especially, T_{P2}>T_{C}. In specific embodiments, T_{P2}−T_{C}≥50° C., such as T_{P2}−T_{C}≥75° C., like T_{P2}−T_{C}≥100° C., especially T_{P2}−T_{C}≥125° C. In yet further embodiments, T_{P2}−T_{C}≥200° C., like T_{P2}−T_{C}≥500° C., such as T_{P2}−T_{C}≥800° C. Hence, in specific embodiments, the metal particles may be first metal particles. In specific embodiments, the composite object may further comprise second metal particles, wherein the (first) metal particles have a first melting temperature T_{P1} and the second metal particles have a second melting temperature T_{P2}, wherein T_{P2}−T_{P1}>100° C.

In embodiments, the (first) metal particles may be substantially spherical. Additionally or alternatively, the second metal particles may comprise extensions.

When the 3D printed material (especially of a “first layer”) comprises both the (first) metal particles and the second metal particles, the combined concentration may in embodiments be selected from the range of 5-60 vol. %, like 10-50 vol. % such as 15-40 vol. %, like 5-20 vol. %. Hence, in specific embodiments the first 3D printed material may comprise the metal particles and the second metal particles at a total concentration selected from the range of 10-50 vol. %.

In specific embodiments, the second metal particles may have at least one aspect ratio of at least 5, such as at least 10.

In specific embodiments, first particles may be provided associated to the second particles. For instance, to a metallic thread as second particle first metal particles may be associated. Such associated particulate material may be combined with thermoplastic material, to provide the 3D printed material.

Hence, in embodiments the first particles may have a different shape than the second particles, with especially the second particles having substantially larger aspect ratios. For instance, a ratio of the aspect ratios of the first particles to the second particles may be smaller than 0.5, such as smaller than 0.1, like even smaller than 0.05.

Note that the first and optional second metal particles may in embodiments essentially only be available in a single layer.

In embodiments, at least part of the 3D printed part may comprise a core-shell layer comprising a core and a shell. Especially, the shell may at least partly enclose the core. The shell may in embodiments comprise the first 3D printed material. The core may in embodiments comprise the second 3D printed material. Hence, in specific embodiments at least part of the 3D printed part comprises a core-shell layer comprising a core and a shell, wherein the shell at least partly encloses the core, wherein the shell comprises the first 3D printed material, and wherein the core comprises the second 3D printed material.

The (with the herein described method) obtained composite object comprising the 3D printed part may be functional per se. For instance, the composite object comprising the 3D printed part may be a lens, a collimator, a reflector, etc., The thus obtained 3D printed part may (alternatively) be used for decorative or artistic purposes. The composite object comprising the 3D printed part may include or be provided with a functional component. The functional component may especially be selected from the group consisting of an optical component, an electrical component, and a magnetic component. The term “optical component” especially refers to a component having an optical functionality, such as a lens, a mirror, a light transmissive element, an optical filter, etc. . . . . The term optical component may also refer to a light source (like a LED). The term “electrical component” may e.g. refer to an integrated circuit, PCB, a battery, a driver, but also a light source (as a light source may be considered an optical component and an electrical component), etc. The term magnetic component may e.g. refer to a magnetic connector, a coil, etc. . . . . Alternatively, or additionally, the functional component may comprise a thermal component (e.g. configured to cool or to heat an electrical component). Hence, the functional component may be configured to generate heat or to scavenge heat, etc. . . . .

As indicated above, the composite object maybe used for different purposes. Amongst others, the composite object maybe used in lighting. Hence, in yet a further aspect the invention also provides a lighting device comprising the composite object as defined herein. In a specific aspect the invention provides a lighting system comprising (a) a light source configured to provide (visible) light source light and (b) the composite object comprising the 3D printed part as defined herein, wherein the composite object comprising the 3D printed part may be configured as one or more of (i) at least part of a housing, (ii) at least part of a wall of a lighting chamber, and (iii) a functional component, wherein the functional component may be selected from the group consisting of an optical component, a support, an electrically insulating component, an electrically conductive component, a thermally insulating component, and a thermally conductive component. Hence, in specific embodiments the composite object may be configured as one or more of (i) at least part of a lighting device housing, (ii) at least part of a wall of a lighting chamber, and (iii) an optical element. As a relative smooth surface may be provided, the composite object may be used as mirror or lens, etc. . . . . In embodiments, the composite object may be configured as shade. A device or system may comprise a plurality of different composite objects, having different functionalities. Additionally or alternatively, the 3D printed part may be used as mirror or lens, etc. . . . . In embodiments, the 3D printed part may be configured as shade. A device or system may comprise a plurality of different 3D printed parts, having different functionalities.

As indicated above, the metal part may be configured as an electrical component, an electrically conductive track, electromagnetic shield or a heatsink or heat spreader. Additionally or alternatively, the metal part may be configured as (part of a) shade. Returning to the 3D printing process, a specific 3D printer may be used to provide the 3D printed item described herein. Therefore, in yet a further aspect the invention also provides a fused deposition modeling 3D printer, comprising (a) a printer head comprising a printer nozzle, and (b) a 3D printable material providing device configured to provide 3D printable material to the printer head, wherein the fused deposition modeling 3D printer is configured to provide said 3D printable material according the method described herein.

The printer nozzle may include a single opening. In other embodiments, the printer nozzle may be of the core-shell type, having two (or more) openings. The term “printer head” may also refer to a plurality of (different) printer heads; hence, the term “printer nozzle” may also refer to a plurality of (different) printer nozzles.

The 3D printable material providing device may provide a filament comprising 3D printable material to the printer head or may provide the 3D printable material as such, with the printer head creating the filament comprising 3D printable material. Hence, in embodiments the invention provides a fused deposition modeling 3D printer, comprising (a) a printer head comprising a printer nozzle, and (b) a filament providing device configured to provide a filament comprising 3D printable material to the printer head, wherein the fused deposition modeling 3D printer is configured to provide said 3D printable material to a substrate, according the method described herein.

Especially, the 3D printer comprises a controller (or is functionally coupled to a controller) that is configured to execute in a controlling mode (or “operation mode”) the method as described herein. Instead of the term “controller” also the term “control system” (see e.g. above) may be applied.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions form a remote control. In embodiments, the control system may be controlled via an App on a device, such as a portable device, like a Smartphone or I-phone, a tablet, etc. The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, WIFI, LiFi, ZigBee, BLE or WiMAX, or another wireless technology.

The system, or apparatus, or device may execute an action in a “mode” or “operation mode” or “mode of operation”. Likewise, in a method an action or stage, or step may be executed in a “mode” or “operation mode” or “mode of operation” or “operational mode”. The term “mode” may also be indicated as “controlling mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme.

Instead of the term “fused deposition modeling (FDM) 3D printer” shortly the terms “3D printer”, “FDM printer” or “printer” may be used. The printer nozzle may also be indicated as “nozzle” or sometimes as “extruder nozzle”.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1c schematically depict some general aspects of the 3D printer and of an embodiment of 3D printed material;

FIGS. 2a-2c schematically depict some further aspects of the invention;

FIGS. 3a-3e schematically depict some aspects of metal particles;

FIGS. 4a-4d schematically depict some further aspects of the invention;

FIGS. 5a-5c schematically depict some further aspects of the invention;

FIG. 6 schematically depicts some aspects of the pretreatment of the metal part; and

FIG. 7 schematically depicts an application. The schematic drawings are not necessarily to scale.

### DETAILED DESCRIPTION OF THE EMBODIMENTS

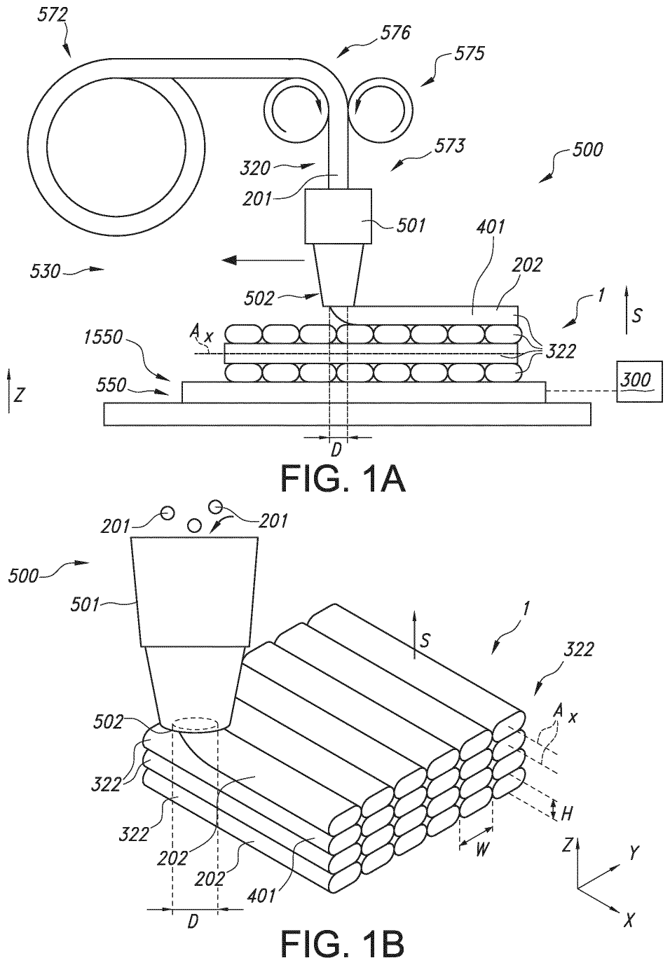

FIG. 1a schematically depicts some aspects of the 3D printer. Reference 500 indicates a 3D printer. Reference 530 indicates the functional unit configured to 3D print, especially FDM 3D printing; this reference may also indicate the 3D printing stage unit. Here, only the printer head for providing 3D printed material, such as an FDM 3D printer head is schematically depicted. Reference 501 indicates the printer head. The 3D printer of the present invention may especially include a plurality of printer heads (see below). Reference 502 indicates a printer nozzle. The 3D printer of the present invention may especially include a plurality of printer nozzles, though other embodiments are also possible. Reference 320 indicates a filament of printable 3D printable material (such as indicated above). Instead of a filament also pellets may be used as 3D printable material. Both can be extruded via the printer nozzle.

For the sake of clarity, not all features of the 3D printer have been depicted, only those that are of especial relevance for the present invention (see further also below). Reference 321 indicates extrudate (of 3D printable material 201).

The 3D printer 500 is configured to generate a 3D printed part 1 by layer-wise depositing on a receiver item 550, which may in embodiments at least temporarily be cooled, a plurality of layers 322 wherein each layer 322 comprises 3D printable material 201, such as having a melting point Tₘ. The 3D printable material 201 may be deposited on a substrate 1550 (during the printing stage). By deposition, the 3D printable material 201 has become 3D printed material 202. 3D printable material 201 escaping from the nozzle 502 is also indicated as extrudate 321. Reference 401 indicates thermoplastic material.

The 3D printer 500 may be configured to heat the filament 320 material upstream of the printer nozzle 502. This may e.g. be done with a device comprising one or more of an extrusion and/or heating function. Such device is indicated with reference 573, and is arranged upstream from the printer nozzle 502 (i.e. in time before the filament material leaves the printer nozzle 502). The printer head 501 may (thus) include a liquefier or heater. Reference 201 indicates printable material. When deposited, this material is indicated as 3D printed material, which is indicated with reference 202.

Reference 572 indicates a spool or roller with material, especially in the form of a wire, which may be indicated as filament 320. The 3D printer 500 transforms this in an extrudate 321 downstream of the printer nozzle which becomes a layer 322 on the receiver item or on already deposited printed material. In general, the diameter of the extrudate 321 downstream of the nozzle 502 is reduced relative to the diameter of the filament 320 upstream of the printer head 501. Hence, the printer nozzle is sometimes (also) indicated as extruder nozzle. Arranging layer 322 by layer 322, a 3D printed part 1 may be formed. Reference 575 indicates the filament providing device, which here amongst others include the spool or roller and the driver wheels, indicated with reference 576.

Reference Ax indicates a longitudinal axis or filament axis.

Reference 300 schematically depicts a control system. The control system may be configured to control the 3D printer 500. The control system 300 may be comprised or functionally coupled to the 3D printer 500. The control system 300 may further comprise or be functionally coupled to a temperature control system configured to control the temperature of the receiver item 550 and/or of the printer head 501. Such temperature control system may include a heater which is able to heat the receiver item 550 to at least a temperature of 50° C., but especially up to a range of about 350° C., such as at least 200° C.

Alternatively or additionally, in embodiments the receiver plate may also be moveable in one or two directions in the x-y plane (horizontal plane). Further, alternatively or additionally, in embodiments the receiver plate may also be rotatable about z axis (vertical). Hence, the control system may move the receiver plate in one or more of the x-direction, y-direction, and z-direction.

Alternatively, the printer can have a head can also rotate during printing. Such a printer has an advantage that the printed material cannot rotate during printing.

Layers are indicated with reference 322, and have a layer height H and a layer width W.

Note that the 3D printable material is not necessarily provided as filament 320 to the printer head. Further, the filament 320 may also be produced in the 3D printer 500 from pieces of 3D printable material. Hence, the nozzle 502 may effectively produce from particulate 3D printable material 201 a filament 320, which upon deposition is indicated as layer 322 (comprising 3D printed material 202). Note that during printing the shape of the extrudate may further be changes, e.g. due to the nozzle smearing out the 3D printable material 201/3D printed material 202. FIG. 1b schematically depicts that also particulate 3D printable material 201 may be used as feed to the printer nozzle 502.

Reference D indicates the diameter of the nozzle (through which the 3D printable material 201 is forced). However, the nozzle is not necessarily circular.

FIG. 1b schematically depicts in 3D in more detail the printing of the 3D printed part 1 under construction. Here, in this schematic drawing the ends of the layers in a single plane are not interconnected, though in reality this may in embodiments be the case. Reference H indicates the height of a layer. Layers are indicated with reference 322. Here, the layers have an essentially circular cross-section. Often, however, they may be flattened, such as having an outer shape resembling a flat oval tube or flat oval duct (i.e. a circular shaped bar having a diameter that is compressed to have a smaller height than width, wherein the sides (defining the width) are (still) rounded).

Hence, FIG. 1a schematically depict some aspects of a fused deposition modeling 3D printer 500, comprising (a) a first printer head 501 comprising a printer nozzle 502, (b) a filament providing device 575 configured to provide a filament 320 comprising 3D printable material 201 to the first printer head 501, and optionally (c) a receiver item 550, which can be used to provide a layer of 3D printed material 202.

FIG. 1b schematically depict some aspects of a fused deposition modeling 3D printer 500 (or part thereof), comprising a first printer head 501 comprising a printer nozzle 502, and optionally a receiver item (not depicted), which can be used to which can be used to provide a layer of 3D printed material 202. Such fused deposition modeling 3D printer 500 may further comprise a 3D printable material providing device, configured to provide the 3D printable material 201 to the first printer head.

In FIGS. 1a-1b, the first or second printable material or the first or second printed material are indicated with the general indications printable material 201 and printed material 202, respectively. Downstream of the nozzle 502, the filament 320 with 3D printable material becomes, when deposited, layer 322 with 3D printed material 202. In FIG. 1b, by way of example the extrudate is essentially directly the layer 322 of 3D printed material 202, due to the short distance between the nozzle 502 and the 3D printed material (or receiver item (not depicted).

FIG. 1c schematically depicts a stack of 3D printed layers 322, each having a layer height H and a layer width W. Note that in embodiments the layer width and/or layer height may differ for two or more layers 322. The layer width and/or layer height may also vary within a layer. Reference 252 in FIG. 1c indicates the item surface of the 3D printed part (schematically depicted in FIG. 1c).

Referring to FIGS. 1a-1c, the filament of 3D printable material that is deposited leads to a layer having a height H (and width W). Depositing layer 322 after layer 322, the 3D printed part 1 is generated. FIG. 1c very schematically depicts a single-walled 3D printed part 1.

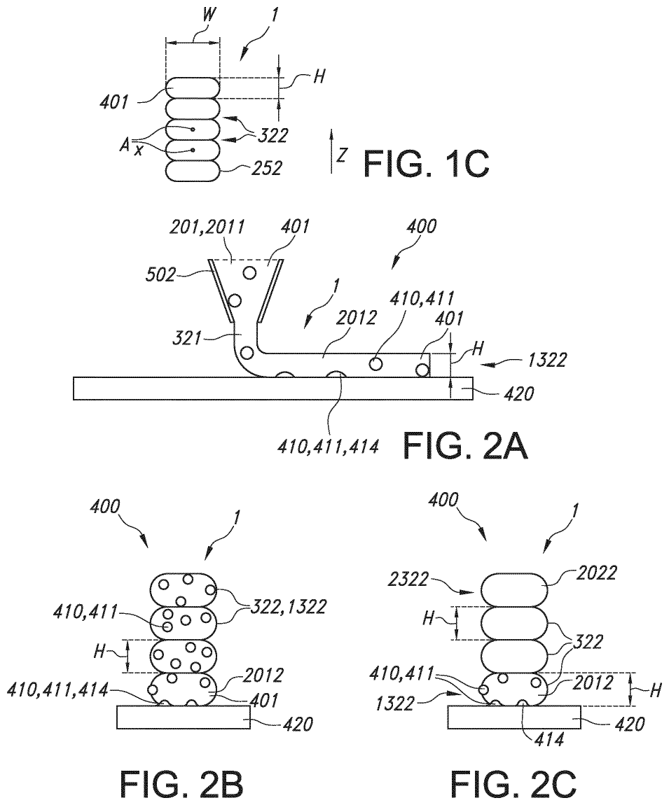

FIG. 2a schematically depicts some aspects of the method for providing an arrangement 400 comprising a 3D printed part 1 adhering to a metal part 420. Especially, the method may comprise providing the metal part 420 followed by a 3D printing stage comprising layer-wise depositing an extrudate 321 comprising 3D printable material 201 by means of fused deposition modeling on the metal part 420. In this way, the composite object 400 of the metal part 420 and the 3D printed part 1 may be provided. Especially, the 3D printed part 1 comprises a layer 322 of 3D printed material 202. The 3D printing stage especially may comprise guiding the 3D printable material 201 through a printer nozzle 502 at a nozzle temperature T_{N} wherein 3D printable material 201 is deposited on the metal part 420. In embodiments, during a first 3D printing stage of the 3D printing stage, the 3D printable material 201 may comprise first 3D printable material 2011 comprising a thermoplastic material 401 and metal particles 410 at least partly embedded therein. The metal particles 410 that form such connection, may be referred to as connecting particles 414. The connecting particles 414 may especially be deformed during deposition. The connecting particles 414 may in embodiments comprise metal particles that were molten, deformed and solidified. The thermoplastic material 401 has a change temperature T_{C} selected from a glass transition temperature T_{G} and a melting temperature T_{M}. The metal 411 of the metal particles 410 has a melting temperature T_{P}. In specific embodiments T_{N}>T_{P}, especially wherein T_{N}−T_{P}≥50° C. Especially, in embodiments T_{N}>T_{C}, such as in embodiments T_{N}−T_{C}≥50° C. In further embodiments |T_{C}−T_{P}|≤50° C. This may facilitate handling of the 3D printable material 201. In embodiments, the metal part may (temporarily) be heated to a temperature higher than T_{P}.

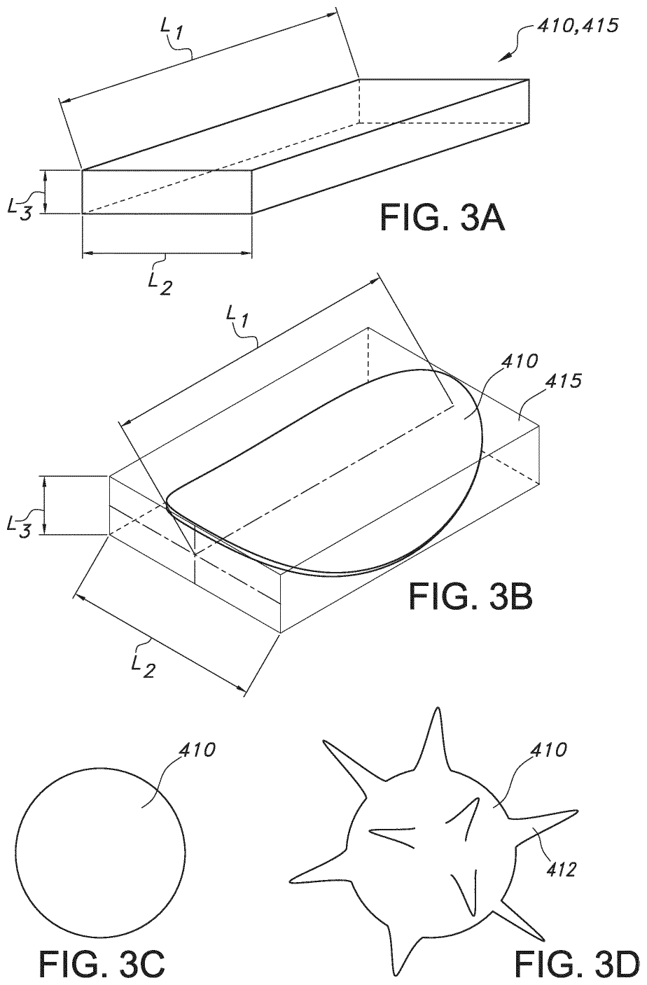

In specific embodiments of the invention T_{C}<T_{P}. However, in alternative embodiments T_{C}>T_{P}. Especially T_{C} may be selected from the range of 150-300° C. In specific embodiments, the method may further comprise controlling during the first 3D printing stage an extrusion rate VE and the nozzle temperature T_{N} to melt at least 50 wt % of the metal 411 in the first 3D printable material 2011. In further embodiments, the metal part may be heated to a temperature >T_{P}. In specific embodiments, the metal 411 of the metal particles 410 may comprise one or more of indium and tin or alloys thereof. As indicated in FIG. 2a, the layer has a layer height H. The metal particles 410 have particle dimensions depicted in FIG. 3 and explained below. In specific embodiments of the method, H<L3.

FIG. 2b schematically depicts an embodiment of the composite object 400 of the invention. Especially, the composite object 400 comprises a metal part 420 and a 3D printed part 1. The 3D printed part 1 comprises a layer 322 of 3D printed material 202, wherein at least part of the 3D printed material 202 comprises a first 3D printed material 2012 comprising a thermoplastic material 401 and metal particles 410 at least partly embedded therein comprising metal 411. In the depicted embodiment, at least part of the metal 411 may be attached to the metal part 420.

FIG. 2c schematically depicts an embodiment of the composite object that may be obtained by the method of the invention wherein the 3D printing stage comprises a second 3D printing stage. Especially, the second 3D printing stage may comprise depositing the 3D printable material 201 on a previously deposited layer 322 i.e. a first layer 1322. Especially, the 3D printable material 201 comprises second 3D printable material 2021 which may comprise a lower content of metal 411 than the first 3D printable material 2011 or may comprise no metal particles 410 (as in the depicted embodiment). The depicted embodiment comprises a first layer 1322 configured in contact with the metal part 420. Especially at least a part of the first layer 1322 may comprise the first 3D printed material 2012 (comprising the metal 411 attached to the metal part 420). In embodiments, the composite object may comprise a second layer 2322 comprising second 3D printed material 2022 comprising a lower content of metal 411 than the first 3D printed material 2012 or comprising no metal 411.

FIGS. 3a-3b schematically depict embodiments of particles 410. FIG. 3a depicts a particle 410 that has a rectangular prism shape, wherein the rectangular prism 415 has a length L1, a width L2 and a height L3, wherein L1≥L2≥L3. FIG. 3b schematically depicts a particle that has a less regular shape such as pieces of broken glass, with a virtual smallest rectangular prism 415 enclosing the particle. The rectangular prism 415 has a length L1, a width L2 and a height L3 wherein L1≥L2≥L3. Further, the rectangular prism 415 has a first aspect ratio is AR1=L1/L3 and a second aspect ratio is AR2=L2/L3.

Further, note that the particles are not essentially oval or rectangular prismoids. The particles may have any shape, especially wherein length L1 is in the range from 30-3000. Of course, the particles may comprise a combination of differently shaped particles. In specific embodiments, the metal particles 410 may be substantially spherical as schematically depicted in FIG. 3c. Alternatively (or additionally), the metal particles 410 may comprise a plurality of extensions 412 as schematically depicted in FIG. 3d. However, the metal particles may in embodiments have any shape.

FIG. 3e schematically depict some embodiments of the metal second metal particles 409. As schematically shown in embodiment I the second metal particles 409 may comprise a plurality of extensions 412. Alternatively, the second metal particles 409 may be substantially spherical (not shown as separate embodiment in this drawing). Alternatively, as schematically depicted in embodiments II-IV, the second metal particles may have a large aspect ratio, such as at least 10. In embodiment II, a rod-like shaped second metal particle 409 is schematically depicted, and in embodiment III, a thread-like shaped second metal particle 409 is schematically depicted. Embodiment IV schematically depicts an associated of a first metal particle 410 and a second metal particle 409. Especially when the latter has a much higher aspect ratio, and extends relative to the former, good connections may be provided.

Also, the particulate material that is embedded in the 3D printable material or is embedded in the 3D printed material may include a broad distribution of particles sizes.

In specific embodiments, the aspect ratios AR1 and AR2 may be individually selected from the range of 1-10000. Especially at least one of AR1 and AR2 is at least 5.

In alternative embodiments, the aspect ratios AR1 and AR2 may be individually selected from the range of 1-2.

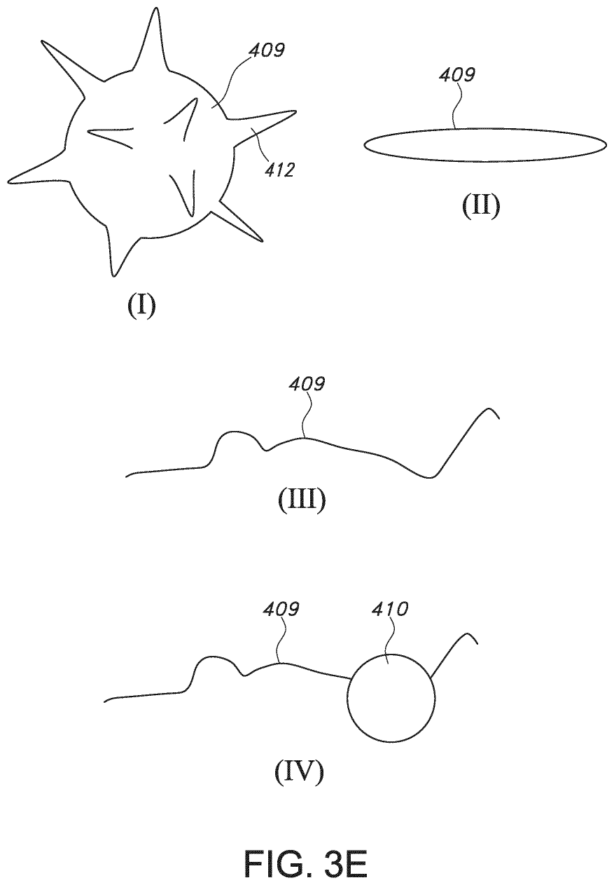

Referring to FIG. 4a, the method may comprise using a 3D printer 500 comprising a core-shell nozzle 5024, wherein the core-shell nozzle 5024 comprises a core nozzle 5025 and a shell nozzle 5026. In embodiments, the shell nozzle may at least partly enclose the core nozzle 5025. The method may further comprise guiding during the 3D printing stage the first 3D printable material 2011 through the shell nozzle 5026 or the core nozzle 5025. Additionally or alternatively, the method may comprise guiding the second 3D printable material 2021, comprising a lower content of metal 411 than the first 3D printable material 2011 or comprising no metal particles 410, through the other one of the shell nozzle 5026 and the core nozzle 5025. In the embodiment depicted in FIG. 4a, the first 3D printable material 2021 is guided through the shell nozzle 5026 and the second 3D printable material 2021 is guided through the core nozzle 5025. In the depicted embodiment, the core-shell layer 5322 has a shell thickness H2, wherein H2<L3. In specific embodiments, the first 3D printable material 2011 may comprise the metal particles 410 at a concentration selected from the range of 10-50 vol. %.

FIG. 4b schematically depicts the composite object 400 wherein at least part of the 3D printed part 1 comprises a core-shell layer 5322 comprising a core 330 and a shell 340. In embodiments, the shell 340 at least partly encloses the core 330. Especially, the core 330 comprises core material 331 and the shell 340 comprises shell material 341. In the depicted embodiment, the shell 340 comprises the first 3D printed material 2012, and the core 330 comprises the second 3D printed material 2022. In the depicted embodiment, at least part of the metal 411 may be attached to the metal part 420.

FIG. 4c depicts a specific embodiment of the composite object 400 which may be obtained by the method comprising guiding during the second 3D printing stage only second 3D printable 2021 and no first 3D printable material 2011 through the core-shell nozzle 5024.

As schematically depicted in FIGS. 2c and 4c, in embodiments the first metal particles and optional second metal particles may in embodiments essentially only be available in a single layer 322 (here the first layer 1322).

FIG. 4d depicts a specific embodiment of the composite object 400 which may be obtained by the method comprising guiding during the first 3D printing stage only first 3D printable 2011 and no second 3D printable material 2021 through the core-shell nozzle 5024 and guiding during the second 3D printing stage only second 3D printable 2021 and no first 3D printable material 2011 through the core-shell nozzle 5024. This method may especially facilitate alternating between the first 3D printing stage and second 3D printing stage. In the depicted embodiment, a first layer 1322 comprises both metal particles 410 and second metal particles 409. Another first layer 1322 of the depicted embodiment comprises only metal particles 410 and no second metal particles 409. In alternative embodiments, all first layers 1322 may comprise metal particles 410 and second metal particles 409. In yet alternative embodiments, all first layers 1322 may comprise only metal particles 410 and no second metal particles 409. Referring to FIG. 4d, the first 3D printed material may comprise the metal particles and the second metal particles at a total concentration selected from the range of 10-50 vol. %.

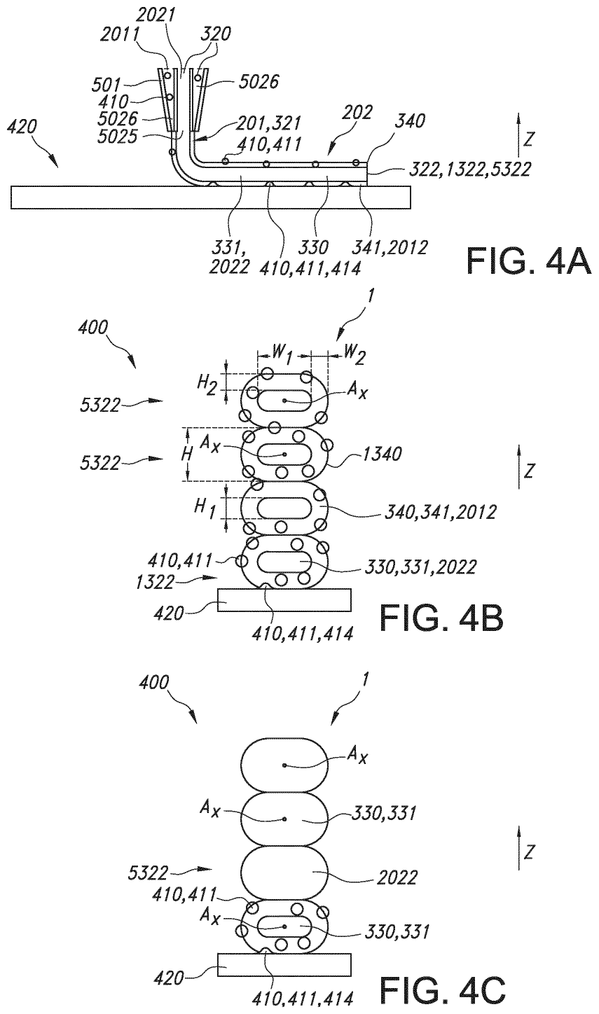

FIG. 5a schematically depicts a filament 320 for producing a 3D printed part 1 by means of fused deposition modelling. The filament 320 may especially comprise first 3D printable material 2011 comprising a thermoplastic material 401 and metal particles 410 at least partly embedded therein. The filament has a thickness Hr. The filament may have a thickness H_{F}. In embodiments 0.2≤L3/H_{F}≤1, such as 0.33L3/H_{F}≤1, e.g. 0.5≤L3/H_{F}≤1, like 0.6≤L3/H_{F}≤0.9. In other embodiments 0.2≤L3/H_{F}≤0.7, like 0.2≤L3/H_{F}≤0.6, such as 0.2≤L3/H_{F}≤0.5. As indicated above, the thermoplastic material 401 has a change temperature T_{C} selected from a glass transition temperature T_{G} and a melting temperature T_{M}. The metal 411 of the metal particles 410 has a melting temperature T_{P}. In specific embodiments, |T_{C}−T_{P}|≤50° C. Especially, the metal 411 of the metal particles 410 may comprise one or more of indium and tin.

FIG. 5b schematically depicts a further embodiment of a filament. Especially, the filament 320 may comprise a core-shell filament 1320 comprising a core 330 comprising second 3D printable material 2021 comprising a lower content of metal 411 than the first 3D printable material 2011 or comprising no metal particles 410, and comprising a shell 340 comprising the first 3D printable material 2011. In specific embodiments, the core-shell filament has a shell thickness H_{2F}, wherein 0.5≤L3/H_{2F}≤1.

FIG. 5c schematically depicts embodiments of a core-shell nozzle 5024, wherein the core-shell nozzle 5024 comprises a core nozzle 5025 and a shell nozzle 5026. Especially, the shell nozzle may at least partly enclose the core nozzle 5025.

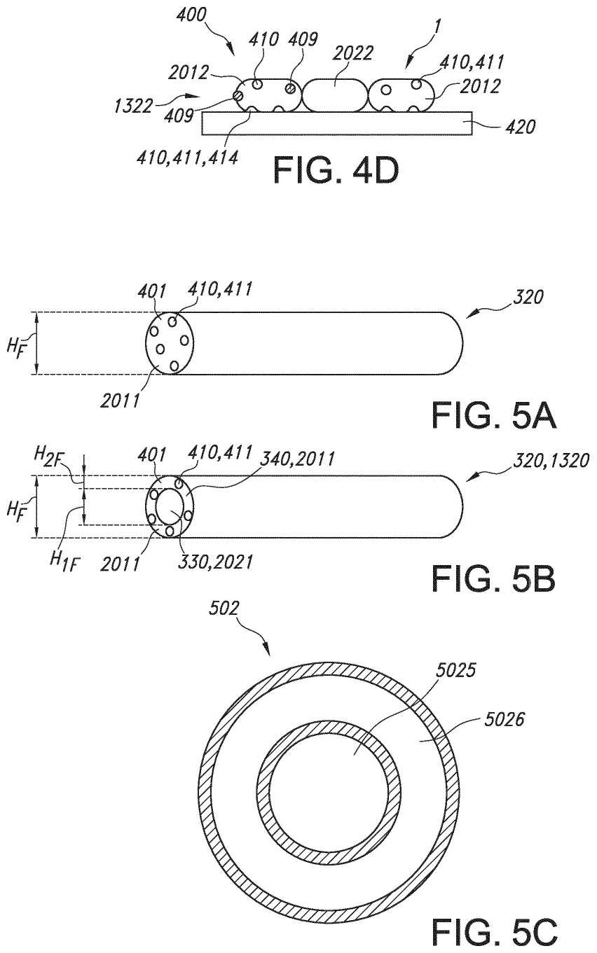

FIG. 6 schematically depicts some further embodiments of the method of the invention. In specific embodiments, the method may comprise executing a pretreatment stage preceding the 3D printing stage. Especially, the pretreatment stage may in embodiments comprise one or more of (i) cleaning the metal part 420, (ii) roughening of the metal part 420, (iii) providing one or more indentations 421 in the metal part 420, and (iv) providing one or more metal part protrusions 422 to the metal part 420.

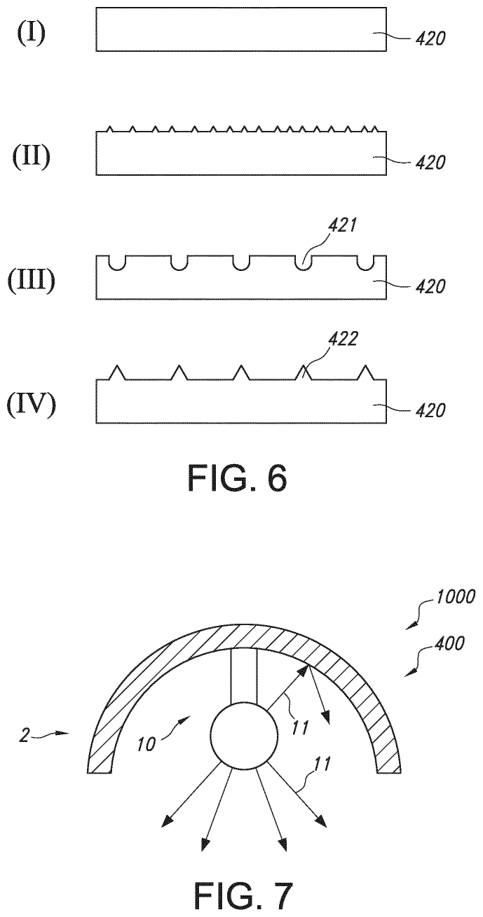

FIG. 7 schematically depicts an embodiment of a lamp or luminaire, indicated with reference 2, which comprises a light source 10 for generating light 11. The lamp may comprise a housing or shade or another element, which may comprise or be the composite object 400. Here, the half sphere (in cross-sectional view) schematically indicates a housing or shade. The lamp or luminaire may be or may comprise a lighting device 1000 (which comprises the light source 10). Hence, in specific embodiments the lighting device 1000 comprises the composite object 400 comprising 3D printed part 1 and metal part 420. The composite object 400 may be configured as one or more of (i) at least part of a lighting device housing, (ii) at least part of a wall of a lighting chamber, and (iii) an optical element. Hence, the 3D printed part may in embodiments be reflective for light source light 11 and/or transmissive for light source light 11. Here, the 3D printed part may e.g. be a housing or shade. The housing or shade comprises the composite object 400.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” includes also embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

It goes without saying that one or more of the first (printable or printed) material and second (printable or printed) material may contain fillers such as glass and fibers which do not have (to have) influence on the on T_{g} or Tₘ of the material(s).

1. A method for providing a composite object comprising a 3D printed part adhering to a metal part wherein:
the method comprises the step of providing the metal part followed by a 3D printing stage comprising layer-wise depositing 3D printable material by means of fused deposition modelling on the metal part, to provide the composite object; wherein the 3D printed part comprises a layer of 3D printed material;
the 3D printing stage comprises guiding the 3D printable material through a printer nozzle at a nozzle temperature T_{N};
during a first 3D printing stage of the 3D printing stage, wherein 3D printable material is deposited on the metal part, the following applies: (i) the 3D printable material comprises first 3D printable material comprising a thermoplastic material and metal particles; wherein metal of the metal particles has a melting temperature T_{P}, and (ii) T_{N}>T_{P}.

2. The method according to claim 1, wherein the thermoplastic material has a change temperature T_{C} selected from a glass transition temperature T_{G} and a melting temperature T_{M}, wherein |T_{C}−T_{P}|≤50° C., wherein T_{N}−T_{C}≥50° C., and wherein T_{N}−T_{P}≥50° C.

3. The method according to claim 1, wherein T_{C}<T_{P}.

4. The method according to claim 1, wherein T_{C}>T_{P}.

5. The method according to claim 1, wherein the 3D printing stage comprises a second 3D printing stage comprising: depositing the 3D printable material on a previously deposited layer, wherein the 3D printable material comprises second 3D printable material comprising a lower content of metal than the first 3D printable material or comprising no metal particles; wherein the metal of the metal particles comprises one or more of indium and tin.

6. The method according to claim 1, wherein the method comprises: using a 3D printer comprising a core-shell nozzle, wherein the core-shell nozzle comprises a core nozzle and a shell nozzle; wherein the method further comprises guiding during the 3D printing stage (i) the first 3D printable material through the shell nozzle and (ii) the second 3D printable material, comprising a lower content of metal than the first 3D printable material or comprising no metal particles, through the core nozzle.

7. The method according to claim 1, wherein the method comprises: executing a pretreatment stage preceding the 3D printing stage, wherein the pretreatment stage comprises one or more of (i) cleaning the metal part, (ii) roughening of the metal part, (iii) providing one or more indentations in the metal part, and (iv) providing one or more metal part protrusions to the metal part.

8. The method according to claim 1, wherein the first 3D printable material further comprises second metal particles, wherein the metal particles have a first melting temperature T_{P1} and wherein the second metal particles have a second melting temperature T_{P2}, wherein T_{N}>T_{P1} and wherein T_{N}<T_{P2}, and wherein the first 3D printable material comprises the metal particles and the second metal particles at a total concentration selected from the range of 10-50 vol. %.

9. The method according to claim 8, wherein the metal particles are spherical, and wherein the second metal particles have at least one aspect ratio of at least 10.

10. A core-shell filament for producing a 3D printed part by means of fused deposition modelling for use in the method according to claim 1, the core-shell filament comprising: (i) a shell comprising the first 3D printable material, and (ii) a core comprising a second 3D printable material comprising a lower content of metal than the first 3D printable material or comprising no metal particles.

11. A composite object comprising a 3D printed part (1) adhering to a metal part, wherein the 3D printed part (1) comprises a layer of 3D printed material, wherein at least part of the 3D printed material comprises a first 3D printed material comprising a thermoplastic material and metal particles comprising metal, wherein at least part of the metal is attached to the metal part, wherein the thermoplastic material has a change temperature T_{C} selected from a glass transition temperature T_{G} and a melting temperature T_{M}, wherein the metal has a melting temperature T_{P}, wherein |T_{C}−T_{P}|≤50° C.; wherein the metal comprises one or more of indium and tin; and wherein the first 3D printed material comprises the metal particles at a concentration selected from the range of 10-50 vol. %.

12. The composite object according to claim 11, wherein the metal part comprises one or more of an electrical component, an electrically conductive track, electromagnetic shield, a heatsink and a heat spreader.

13. The composite object according to claim 11, comprising (i) a first layer configured in contact with the metal part, wherein at least a part of the first layer comprises the first 3D printed material and (ii) a second layer comprising second 3D printed material comprising a lower content of metal than the first 3D printed material or comprising no metal, wherein the first 3D printed material further comprises second metal particles, wherein the metal particles have a first melting temperature T_{P1} and wherein the second metal particles have a second melting temperature T_{P2}, wherein T_{P2}−T_{P1}>100° C.

14. The composite object according to claim 11, wherein at least part of the 3D printed part comprises a core-shell layer comprising a core and a shell, wherein the shell at least partly encloses the core, wherein the shell comprises the first 3D printed material, and wherein the core comprises the second 3D printed material as defined in claim 13.

15. A lighting device comprising the composite object according to claim 11, wherein the composite object is configured as one or more of (i) at least part of a lighting device housing, (ii) at least part of a wall of a lighting chamber, and (iii) an optical element.
